(19) United States
(12) Patent Application Publication
(10) Pub. No.: US 2026/0281234 A1
(43) Pub. Date: Sep. 17, 2026

(54) SYSTEM

(71) Applicant: SoftBank Group Corp., Tokyo (JP)

(72) Inventor: Tetsuya UNO, Tokyo (JP)

(73) Assignee: SoftBank Group Corp., Tokyo (JP)

(21) Appl. No.: 19/550,347

(22) Filed: Feb. 26, 2026

Related U.S. Application Data
(60) Provisional application No. 63/770,739, filed on Mar. 12, 2025.

(51) Int. Cl. H04M 3/22; G06F 40/289; G06F 40/40; G06N 3/0475

(52) U.S. Cl. CPC H04M 3/2281; G06F 40/289; G06F 40/40; G06N 3/0475

(57) ABSTRACT

A system includes a processor that is configured to monitor, in real time, a voice call received on a user device, and convert content of the voice call into text data by using a speech recognition technique; wherein the processor is configured to analyze the converted text data by using a natural language processing technique and detect a keyword or a phrase related to phishing fraud; and wherein the processor is configured to issue a warning to a user when a possibility of phishing fraud is detected, wherein all of said monitoring, conversion, analysis, detection, and issuing are performed locally on the user device so as to protect privacy of the user.

### CROSS-REFERENCE TO RELATED APPLICATION

This application claims the benefit of U.S. Provisional Application No. 63/770,739, filed on Mar. 12, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional phishing detection technologies for voice calls and emails generally rely on server-side processing, in which audio data, call transcripts, email contents, or related metadata are transmitted from a user device to a remote server for analysis. Such approaches create significant privacy and security concerns, because sensitive information contained in the calls or emails may be exposed to third parties or intercepted during transmission. In addition, dependence on network connectivity and server availability can degrade real-time responsiveness and reliability of phishing detection, particularly during live voice calls where immediate feedback to the user is required. Existing client-side solutions often provide only simple keyword-based filtering and lack sufficient contextual understanding to accurately detect sophisticated phishing attacks, leading to both false positives and false negatives. Furthermore, many known techniques do not provide an integrated mechanism that simultaneously addresses real-time monitoring of voice calls, natural language analysis of call content, and analysis of email data, while ensuring that all processing remains local on the user device.

Accordingly, there is a need for a system that is capable of monitoring voice calls on a user device in real time, converting call audio into text using speech recognition, analyzing the resulting text using natural language processing to detect phishing-related expressions, and issuing appropriate warnings to the user, all without transmitting call or email content off the device. There is a further need for a system that is capable of analyzing email subjects, bodies, and sender information locally on the user device to detect phishing-related features such as impersonated sender domains, fraudulent links, and potentially malicious attachments, while preserving the user's privacy and providing timely, actionable warnings against phishing attacks.

### SUMMARY

In order to solve the above-described problems, an aspect of the present invention provides a system comprising a processor, wherein the processor is configured to monitor, in real time, a voice call received on a user device, and convert content of the voice call into text data by using a speech recognition technique. The processor is further configured to analyze the converted text data by using a natural language processing technique and detect a keyword or a phrase related to phishing fraud. When a possibility of phishing fraud is detected based on the analysis, the processor is configured to issue a warning to a user. In this aspect, all of the monitoring, conversion, analysis, detection, and issuing are performed locally on the user device so as to protect privacy of the user, thereby avoiding transmission of call content or transcripts to an external server and enabling immediate notification during an ongoing call. In another aspect, the processor of the system is configured to perform all processing for the monitoring of the voice call, the conversion of the content of the voice call into the text data, the analysis of the converted text data, the detection of the keyword or the phrase related to phishing fraud, and the issuing of the warning to the user locally on the user device so as to protect the privacy of the user. By integrating these functions in a single local processing framework, the system ensures that sensitive audio and textual data remain confined to the user device while still enabling sophisticated, context-aware phishing detection.

In a further aspect, the processor of the system is further configured to analyze a subject, a body, and sender information of an email received on the user device and detect a feature related to phishing fraud. In particular, the processor is configured to issue the warning when at least one of a sender address impersonates an official domain, a link destination is an unauthorized website, or an attached file potentially includes a malicious program. The processor is configured to perform the analysis of the email data, the detection of phishing-related features, and the issuing of the warning locally on the user device so as to protect the privacy of the user. Thus, the system provides an integrated, on-device solution for both voice-call-based and email-based phishing detection, enabling real-time protection while maintaining user privacy.

The term “system” refers to the entirety of hardware and software components, including at least one processor and associated memory, configured collectively to perform the functions recited in the claims.
The term “processor” refers to one or more hardware processing units, such as a central processing unit (CPU), digital signal processor (DSP), microcontroller, or system-on-chip (SoC), and any combination thereof, capable of executing instructions to perform the claimed operations.
The term “user device” refers to an electronic device operated directly or indirectly by a user, such as a smartphone, tablet, laptop computer, desktop computer, or wearable device, that includes the processor and executes at least a portion of the claimed functions.
The term “voice call” refers to a real-time audio communication session between two or more parties, conducted over a telecommunication network, Voice over IP (VOIP) network, or similar communication infrastructure, in which spoken audio is exchanged.
The term “monitor” refers to continuously or periodically observing, receiving, or accessing data associated with an ongoing voice call, including at least audio data, for the purpose of processing as recited in the claims.
The term “speech recognition technique” refers to any algorithm, model, or computational method that converts spoken audio input into corresponding text data, including but not limited to statistical, neural network-based, or rule-based speech recognition systems.
The term “text data” refers to a digital representation of language in textual form, generated from voice call audio or email content, which is suitable for subsequent analysis by language processing algorithms.
The term “natural language processing technique” refers to any algorithm, model, or computational method that analyzes human language in textual form, including techniques for tokenization, parsing, semantic analysis, classification, or pattern recognition, in order to infer meaning or detect specific expressions.
The term “keyword or phrase related to phishing fraud” refers to a word, a sequence of words, or a linguistic pattern that is indicative of an attempt to fraudulently acquire sensitive information, such as passwords, account numbers, or personal identifiers, by impersonation or deception.
The term “phishing fraud” refers to a fraudulent activity in which an attacker attempts to obtain sensitive information, induce unauthorized actions, or compromise security by disguising as a trustworthy entity in an electronic communication, including but not limited to calls and emails.
The term “warning” refers to a notification, alert, or message presented to the user, in visual, auditory, or tactile form, that indicates a detected possibility of phishing fraud and may include guidance on how the user should respond.
The term “locally” refers to processing that is performed within the user device itself, without transmitting the corresponding raw audio data, full text data, or detailed content to an external server for the core detection operations described in the claims.
The term “privacy of the user” refers to protection of information associated with the user, including call audio, call transcripts, email content, and identifying data, from unauthorized access, disclosure, or transmission outside the user device during the claimed operations.
The term “email” refers to an electronic message transmitted over an electronic mail system and including at least a subject, a body, sender information, and optionally one or more attachments or embedded links.
The term “subject” refers to a textual field of an email that summarizes or indicates the topic or purpose of the email.
The term “body” refers to the main textual content of an email, excluding header fields such as the subject and sender information, and including any in-line text visible to the user.
The term “sender information” refers to data identifying the origin of an email, including at least a sender address and, optionally, display name, domain, and other header fields associated with the sender.
The term “feature related to phishing fraud” refers to any characteristic of an email, including patterns in subject, body, sender information, links, or attachments, that is indicative of phishing fraud, such as domain impersonation, suspicious URLs, or unusual attachment behavior.
The term “sender address impersonates an official domain” refers to a condition in which an email's sender address appears similar to, but is not actually associated with, a legitimate or official domain, such as by using misspellings, visually similar characters, or deceptive subdomains.
The term “link destination is an unauthorized website” refers to a condition in which a hyperlink contained in an email points to a website that is not associated with a legitimate or official service expected by the user and is instead intended to deceive or compromise the user.
The term “attached file potentially includes a malicious program” refers to a condition in which a file attached to an email has characteristics, such as file type, name, or known signatures, suggesting that it may contain malware, executable code, or other content capable of harming the user device or compromising security.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

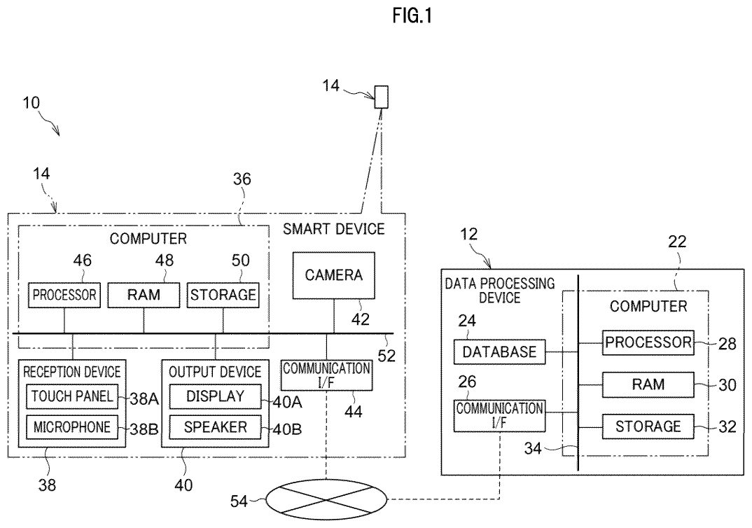

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

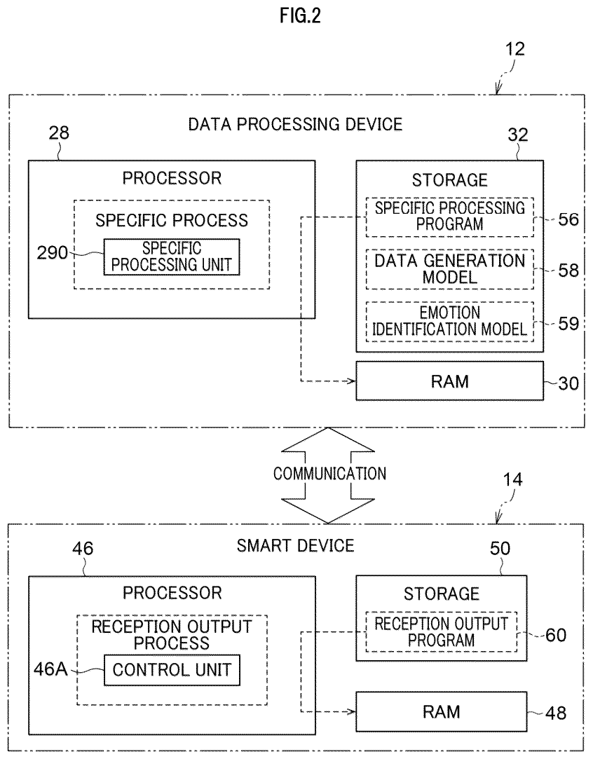

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional communication security systems, detection of fraudulent activity such as phishing frequently relies on centralized analysis on remote servers. Audio information from calls and textual information from messages are often uploaded in raw or weakly processed form to a remote processing environment, where pattern matching and classification are executed. This architecture increases latency, consumes network bandwidth, and, most critically, exposes sensitive communication contents to external entities, thereby creating additional privacy and security vulnerabilities beyond the original threat of phishing itself.

Furthermore, many existing phishing-detection mechanisms are primarily rule-based and depend on static keyword lists or manually curated patterns. Such mechanisms struggle to keep pace with rapidly evolving fraudulent techniques that intentionally avoid obvious trigger words, use obfuscated expressions, or exploit multi-lingual and cross-channel attack vectors combining voice calls, messages, and embedded links. Updating these rule sets and classification models typically requires manual expert work and batch retraining pipelines, which are slow, resource-intensive, and difficult to adapt to device-level constraints, leading to stale detection logic deployed on user terminals.

In addition, conventional on-device approaches that do exist are often limited to simple filtering and do not perform integrated processing across audio, textual, and link information. They rarely utilize contextual machine learning models that jointly evaluate rule-based pattern matches, user-specific communication patterns, and anomaly signals. As a result, such systems either produce a high false-positive rate that degrades usability or a high false-negative rate that allows sophisticated fraudulent activity to pass undetected. These shortcomings constitute a technical problem of how to design a computing system that performs real-time, privacy-preserving, and adaptive detection of fraudulent activity across multiple communication modalities directly on a user terminal.

Moreover, although generative artificial intelligence models have become capable of producing realistic phishing content and sophisticated linguistic patterns, existing security systems do not effectively leverage these models in a structured and automated manner to improve detection logic. In particular, there is no integrated mechanism that uses prompt sentences to drive a generative artificial intelligence model for the automated creation of new training data, phrase pattern information, and detection rules, and then systematically feeds these outputs into machine learning models that are deployable on resource-constrained user terminals. This gap results in underutilization of powerful generative capabilities for improving the core computing functions of phishing detection, namely model updating, pattern generation, and rule refinement.

Accordingly, there is a need for an improved computer-implemented system that: (i) performs on-device signal processing, natural language processing, and risk evaluation for fraudulent activity without transmitting raw communication content to a server; (ii) integrates rule-based detection, contextual machine-learning-based detection, and anomaly detection based on user-specific communication history; and (iii) coordinates with an external server that uses a generative artificial intelligence model, driven by structured prompt sentences, to automatically generate and update phrase pattern information, destination information pattern information, and machine learning model parameters. Such a system would improve core computer technology by enhancing the efficiency, adaptability, and privacy properties of phishing-detection computation executed on general-purpose processors.

The specific processing by the specific processing unit 290 of the data processing device 12 in Example 1 is realized by the following means.

The present invention provides a server comprising processing circuitry configured to communicate with one or more user terminals, to store and manage phrase pattern information and destination information pattern information related to fraudulent activity, and to store and manage a machine learning model for classifying fraudulent activity based on character information and message information. This enables centralized maintenance of abstract detection knowledge while allowing user terminals to perform local, privacy-preserving inference using updated patterns and models.

The present invention further provides a server comprising processing circuitry configured to generate, in accordance with a predetermined specification, a prompt sentence that instructs a generative artificial intelligence model to output at least one of: sentence examples representing fraudulent activity, phrase patterns indicative of fraudulent activity, candidate detection rules, and training data for the machine learning model; to input the prompt sentence into the generative artificial intelligence model; and to receive response information from the generative artificial intelligence model including candidate information related to fraudulent activity. This enables automated and scalable generation of rich training data and rule candidates that are tailored to current and emerging fraudulent techniques.

The present invention further provides a server comprising processing circuitry configured to filter, normalize, and label the candidate information obtained from the generative artificial intelligence model; to generate, based on the filtered candidate information, updated phrase pattern information, updated destination information pattern information, and updated training data sets for the machine learning model; and to train or update the machine learning model using the updated training data sets. This enables continuous improvement of the classification performance of the machine learning model in an automated pipeline that incorporates generative outputs while maintaining control over data quality.

The present invention further provides a server comprising processing circuitry configured to package the updated phrase pattern information, the updated destination information pattern information, and updated parameters of the trained or updated machine learning model into versioned update information; to provide the update information to the user terminals over a secure communication channel; and to manage version control and compatibility information corresponding to different user terminal capabilities. This enables efficient deployment of improved detection logic to heterogeneous user terminals while minimizing communication overhead and ensuring that each terminal receives compatible updates.

The present invention further provides a server comprising processing circuitry configured to instruct the user terminals, through configuration data included in the update information, to perform on-device processing including: acquiring audio information and message information; executing signal processing, speech recognition, language determination, and character normalization; executing rule-based pattern matching using the phrase pattern information; executing machine-learning-based classification using the machine learning model; executing link analysis using the destination information pattern information; and calculating a risk evaluation value for fraudulent activity without transmitting individual contents of the audio information or message information to the server. This enables a division of labor in which computationally intensive training and pattern generation occur on the server side, while inference and sensitive data handling occur locally on user terminals.

The present invention further provides a server comprising processing circuitry configured to instruct the user terminals to compute an abnormality degree based on a difference between current communication features and a normal communication pattern derived from past communication history stored locally on the user terminals; and to instruct the user terminals to correct the risk evaluation value according to the abnormality degree. This enables incorporation of user-specific anomaly detection into the overall risk evaluation, thereby improving detection accuracy while keeping user-specific historical data on the terminal.

The present invention further provides a server comprising processing circuitry configured to, based on feedback information received from user terminals regarding false positives and false negatives, adjust parameters of the prompt sentences, select or weight candidate outputs from the generative artificial intelligence model, and subsequently refine the phrase pattern information, the destination information pattern information, and the machine learning model. This enables a feedback loop that adaptively tunes both the generative prompting process and the downstream discriminative models, thereby improving the technical performance and robustness of the overall phishing-detection system.

The term “audio information” refers to time-varying signal data representing sound captured or received by a user terminal, including at least voice signals associated with a communication session and optionally background noise or other acoustic components.
The term “character information” refers to digital text data obtained by converting audio information through speech recognition processing or by acquiring textual content directly from message information, and includes sequences of symbols, letters, numerals, and punctuation.
The term “message information” refers to electronically transmitted communication data other than raw audio information, including at least subject information, body information, sender information, and link information associated with an electronic message.
The term “subject information” refers to a text field of message information that summarizes or titles the content of the message.
The term “body information” refers to a text field of message information that includes the main textual content of the message, including sentences, paragraphs, and embedded textual elements.
The term “sender information” refers to data indicating an origin of message information, including at least a sender address, a sender name, or other identifiers associated with a source of the message.
The term “link information” refers to data representing one or more references to external resources contained in message information, including at least destination information such as network addresses or resource identifiers.
The term “destination information” refers to a character string or encoded data that specifies a location of a resource accessible over a communication network, including, for example, a network address, a domain name, or a path.
The term “signal processing” refers to computational operations applied to audio information, including at least sampling, filtering, noise suppression, and echo cancellation, for the purpose of improving quality or preparing the data for further analysis.
The term “noise suppression” refers to a type of signal processing that reduces or removes components of audio information that are not part of a desired voice signal, such as background sounds or interference.
The term “speech recognition process” refers to a computational procedure that converts audio information representing spoken language into corresponding character information by using pattern recognition or machine learning techniques.
The term “language determination processing” refers to a computational procedure that identifies a natural language or languages used in character information.
The term “character normalization processing” refers to operations that transform character information into a standardized representation, including at least case conversion, script normalization, or removal of redundant characters.
The term “rule-based processing” refers to processing that evaluates character information or message information by applying predetermined rules or patterns, including phrase pattern information or destination information pattern information, to detect indicators of fraudulent activity.
The term “statistical processing” refers to processing that uses numerical or probabilistic methods, including a machine learning model, to compute a value indicative of a likelihood or risk of fraudulent activity based on input features derived from character information or message information.
The term “contextual information” refers to information about relationships among words, phrases, or sentences in character information, including order, proximity, and semantic association, used as features in statistical processing.
The term “risk value” refers to a numerical or categorical quantity computed by statistical processing that represents an estimated likelihood or severity of fraudulent activity for given character information or message information.
The term “risk evaluation value” refers to a value obtained by integrating at least a result of rule-based processing and a result of statistical processing, and that is used to determine whether a given communication instance is classified as fraudulent or suspicious.
The term “threshold” refers to a predefined or adaptively updated limit value that is compared with the risk evaluation value in order to determine whether a warning should be generated or further processing should be performed.
The term “weighting information” refers to parameters used to adjust contributions of different features, scores, or detection components, including rule-based processing results, statistical processing results, or anomaly detection results, when calculating a risk evaluation value.
The term “operation means” refers to user interface elements presented on a user terminal, including buttons, icons, links, or other interactive controls, that receive operation content from a user in response to warning information.
The term “operation content” refers to input data generated by a user's interaction with operation means, such as selection of an action, confirmation, dismissal, or override of a warning.
The term “communication management processing” refers to processing that controls exchange of data between a user terminal and an external server, including connection establishment, authentication, data transfer, error handling, and update acquisition.
The term “external server” refers to a computing apparatus or group of computing apparatuses located remotely from a user terminal and configured to perform at least management of phrase pattern information, destination information pattern information, a machine learning model, and interaction with a generative artificial intelligence model.
The term “phrase pattern information” refers to data defining one or more textual patterns, templates, or expressions that are indicative of fraudulent activity when present in character information or message information.
The term “destination information pattern information” refers to data defining patterns or conditions for destination information, such as structural characteristics of network addresses or domains, that are indicative of fraudulent or suspicious destinations.
The term “machine learning model” refers to a computational model trained using machine learning algorithms to classify or score character information or message information with respect to likelihood of fraudulent activity.
The term “generative artificial intelligence model” refers to a computational model that generates text or other data in response to input, including large-scale neural network models configured to produce candidate sentence examples, phrase patterns, detection rules, or training data.
The term “prompt sentence” refers to a sequence of characters or tokens that describes a task or instruction given to a generative artificial intelligence model in order to obtain desired response information related to fraudulent activity.
The term “candidate information” refers to output data from a generative artificial intelligence model, including at least sentence examples, phrase patterns, and detection rule proposals, that is subject to further filtering, normalization, and labeling.
The term “learning data” refers to data sets that include at least input features and associated labels or target values, used to train or update a machine learning model.
The term “update information” refers to data that specifies new or modified versions of phrase pattern information, destination information pattern information, or parameters of a machine learning model for deployment to user terminals.
The term “storage device of the user terminal” refers to any memory or storage unit, including volatile or non-volatile memory, that is physically associated with the user terminal and is used to store information for local processing.
The term “communication history information” refers to data representing past communication events on a user terminal, including attributes of calls or messages, that is used to derive a normal communication pattern.
The term “normal communication pattern” refers to a statistical profile or model of typical communication behavior for a user or user terminal, derived from communication history information.
The term “abnormality degree” refers to a value that quantifies a deviation between features of current communication and the normal communication pattern.
The term “feedback information” refers to data sent from a user terminal to an external server that indicates correctness or incorrectness of detection results, including information about false positives, false negatives, or user overrides.
The term “warning information” refers to data that indicates detection of a potential fraudulent activity, including explanatory content and suggested avoidance actions, and that is presented to the user.

In one embodiment, a terminal executes an application program on a general-purpose processor that cooperates with memory, a wireless communication interface, an audio input device, a display, and an input device. The terminal executes an operating system such as a mobile operating system or a desktop operating system. The terminal further uses a speech recognition engine (for example, an engine based on a recurrent neural network or a transformer, such as a model similar to Vosk or DeepSpeech), a natural language processing engine (for example, a model similar to a transformer-based text classifier such as BERT or DistilBERT), and a local database engine (for example, a relational database library embedded in the terminal).

The terminal converts audio information into character information by using the speech recognition engine. The terminal samples an analog audio signal received from a microphone, digitizes the signal at a given sampling frequency (for example, 8 kHz to 16 kHz for telephony), and stores digitized samples in fixed-length audio frames. The terminal applies signal processing such as windowing, fast Fourier transform, spectral subtraction, and noise suppression to each frame. The terminal then feeds sequences of processed frames into an acoustic model represented as a neural network having multiple layers, such as convolutional layers followed by recurrent layers or transformer layers. The terminal calculates posterior probabilities over phonetic units or subword units and then uses a decoder with a language model to output character sequences as character information. Because the terminal performs these operations locally without transmitting the audio frames to a server, the terminal reduces communication load and protects the user's privacy.

The terminal normalizes the character information by executing language determination processing and character normalization processing. The terminal determines a language for each sentence by evaluating character frequency vectors or by applying a lightweight language identification model, and then applies language-specific normalization rules. For example, the terminal converts full-width characters to half-width characters, unifies different encodings of similar symbols, converts text to lowercase where meaningful, and removes repeated filler words that do not affect semantic content. The terminal segments the normalized text into sentences using punctuation, pause markers derived from timing information of the audio frames, and learned boundary probabilities from a sentence boundary detection model. This structured character information forms an internal data structure that stores sentences as an ordered list, each sentence being associated with language tags and metadata.

The terminal maintains phrase pattern information and destination information pattern information in the local database. The terminal stores each phrase pattern as an entry containing a normalized text representation, optional regular expression patterns, language tags, and severity scores. The terminal stores each destination information pattern as an entry containing structural templates for network addresses, domain labels, and path components, including length thresholds, character-class constraints, and blacklisted subdomains. By using these structured pattern representations, the terminal executes rule-based processing by matching each sentence of the character information and each destination string in message information against the stored patterns.

The terminal executes statistical processing by using a machine learning model loaded from non-volatile storage into memory. The machine learning model can be, for example, a transformer-based text classifier converted into a compact format such as a lite-optimized representation (for instance, a reduced-parameter ONNX or TensorFlow Lite model). The terminal tokenizes each sentence into subword units by applying a pre-defined tokenizer that maps character sequences to token identifiers. The terminal then constructs input sequences that include special tokens (such as classification tokens and separator tokens), and converts token identifiers into dense vector representations using an embedding matrix. The terminal processes the embeddings through multiple self-attention layers and feed-forward layers, using learned weight matrices and non-linear activation functions. The terminal obtains a contextual embedding for each sentence or for the entire conversation and passes this embedding through a classification head, which consists of one or more fully connected layers and a softmax layer or sigmoid layer, to compute a risk value representing a probability that the content corresponds to fraudulent activity.

The terminal integrates the risk value from the machine learning model with rule-based processing results. The terminal computes a rule score by aggregating severity scores of matched phrase patterns and destination information patterns, possibly weighted by recency and context. The terminal then calculates a risk evaluation value by combining the rule score, the machine-learning-based risk value, and an anomaly score, using weighting information stored in configuration data. This combination can be a weighted sum or a more complex non-linear function that has been calibrated on a development dataset. By integrating heterogeneous signals, the terminal achieves higher detection precision compared to either rule-only or statistical-only approaches.

The terminal maintains communication history information in a local storage device. The terminal records metadata about past calls and messages, such as caller identifiers, sender addresses, time of day, typical length, topics as inferred from topic models, and aggregate statistics of used vocabulary. The terminal derives a normal communication pattern by computing statistical profiles such as probability distributions over senders, typical phrase usage, and typical link structures. When the terminal processes current communication, the terminal computes feature vectors representing similarity or deviation from the normal communication pattern, such as Kullback-Leibler divergence between topic distributions or distance between sender patterns. The terminal calculates an abnormality degree as a scalar derived from these differences and uses this abnormality degree to adjust the risk evaluation value. This anomaly detection processing allows the terminal to capture user-specific irregularities that are difficult to express through generic rules.

The terminal performs message analysis for message information, such as electronic mail and application notifications. The terminal acquires subject information, body information, sender information, and link information using an application programming interface provided by the operating system or a messaging application. The terminal parses link information by separating protocol, domain, subdomain, top-level domain, path, and query parameters, and then compares each component with destination information pattern information. For example, the terminal can detect suspicious domains with excessive subdomain depth, unusual character sequences, or mismatches between displayed text and actual link destination. Because the terminal performs parsing at the character-string level and applies patterns that specify structural constraints rather than only simple substrings, the terminal can detect obfuscated or slightly modified domains more effectively.

The terminal presents warning information to the user when the risk evaluation value exceeds a threshold stored in local configuration data. The terminal causes the display to render a popup window or banner including a description of the suspected fraudulent activity, highlighted portions of phrases that triggered detection, and concrete suggested avoidance actions, such as not disclosing personal data or not activating certain links. The terminal also causes an audio output device to play an alert tone if configured. The terminal presents operation means, such as buttons labeled “Terminate call,” “Delete message,” or “Mark as safe,” and acquires operation content when the user selects an option. The terminal uses this operation content to adjust thresholds and weighting information, thereby adapting sensitivity to the user's preferences and actual false-positive or false-negative experiences.

The server operates as a remote computing apparatus or group of apparatuses that manage pattern information, model parameters, and interaction with a generative AI model. The server executes server-side software on one or more processors with access to high-capacity storage, network interfaces, and optional hardware accelerators such as graphics processing units. The server maintains a central database storing phrase pattern information, destination information pattern information, machine learning model versions, and performance metrics. The server communicates with multiple terminals over secure communication channels and distributes update information that packages new pattern entries and updated model parameters.

The server uses a generative AI model hosted either on the same hardware platform or on an associated computational resource. The generative AI model is implemented as a large neural network with an encoder-decoder or decoder-only architecture, trained with autoregressive or masked language modeling objectives. The server constructs prompt sentences that describe specific generation tasks and provides context examples. Example prompt sentences include:
“Generate realistic phishing phone call scripts in which an attacker impersonates a financial institution and asks a user to provide account numbers and passwords.”
“Generate email bodies in English, Japanese, and Spanish that attempt to trick a user into clicking a malicious link by claiming that the user's account has been suspended and must be verified immediately.”
“Propose robust linguistic rules and semantic patterns to detect phishing attempts even when the attacker avoids obvious keywords; provide multiple examples for each pattern.”

The server inputs these prompt sentences into the generative AI model and receives candidate information in the form of generated text. The server parses the generated text into structured elements: sentence examples, phrase pattern candidates, and proposed detection rules. The server filters out irrelevant or low-quality candidates by applying automated filters, such as checking for minimum length, removing duplicates based on similarity metrics, and evaluating diversity. The server then labels the remaining candidates with metadata such as language, scenario type, and severity level.

The server generates learning data by pairing generated sentences with labels indicating whether they represent fraudulent activity or legitimate communication, and by assigning pattern identifiers to examples that embody particular phrase patterns. The server augments this learning data with real-world samples collected from threat intelligence sources, optionally anonymized and normalized. The server then trains or fine-tunes the machine learning model by using mini-batch gradient descent on this dataset. The server computes a loss function such as cross-entropy between predicted probabilities and true labels, and updates model weights by backpropagation. The server may apply regularization techniques such as dropout and weight decay to prevent overfitting, and may perform data augmentation by paraphrasing, language translation, or controlled distortion of benign messages into borderline cases. By incorporating generative outputs into the training loop, the server can populate rare or emerging attack patterns that might not yet be sufficiently represented in naturally observed data.

The server evaluates candidate versions of the machine learning model on validation and test datasets. The server computes performance metrics such as precision, recall, false positive rate, and area under the ROC curve. The server selects a model version that satisfies predetermined trade-offs between detection accuracy and computational complexity fit for execution on terminals. The server compresses the selected model, for example by quantization of weights or pruning of redundant neurons, and exports the model in a format suitable for terminal inference. The server packages this model with updated phrase pattern information and destination information pattern information as update information and transmits it to terminals over secure communication connections.

The server also uses feedback information from terminals to improve the generative prompting strategy and model configuration. When a terminal indicates that certain alerts are frequent false positives or that certain suspicious behaviors were not detected, the server aggregates this information while removing identifiers or content details to preserve privacy.

The server then modifies prompt sentences to request additional examples specifically targeting the problematic patterns and adjusts weights assigned to candidate outputs from the generative AI model. For instance, the server can add instructions such as “Generate examples that are difficult to distinguish from legitimate notifications but still request sensitive information.” This adaptive loop allows the server to refine not only discriminative models but also the generation behavior of the generative AI model, leading to improved technical performance over time.

The terminal benefits from these server-side operations by receiving updated pattern information and model parameters that are optimized for execution on limited hardware. The terminal loads the updated models into memory and uses them during its detection computations. Because the models are trained using diverse generative examples and real-world data, the terminal can detect a wider variety of fraudulent behaviors while using limited computational resources. The combination of rule-based patterns and learned models improves detection accuracy and reduces latency in producing risk evaluation values, which is particularly important for real-time scenarios such as ongoing calls.

The terminal and the server together implement a data flow that reduces network usage and enhances privacy. The terminal never transmits raw audio information, raw character information, or raw message content to the server. Instead, the terminal transmits only aggregate feedback information, version identifiers, and error statistics, if transmission is allowed by configuration. As a result, bandwidth consumption is minimized, and the risk of exposing communication content to external entities is reduced. At the same time, the server concentrates computationally heavy training and pattern generation operations, so that individual terminals do not need to perform these tasks.

The described architecture improves computer technology in several ways. The terminal uses specialized data structures and algorithms for combining signal processing, language processing, rule-based pattern detection, and machine-learning-based scoring within a constrained environment. By structuring the character information into sentences with language tags and by storing phrase pattern information and destination information pattern information in normalized pattern tables, the terminal can perform complex matching operations with deterministic time bounds. The use of a compact transformer model with quantized weights and reduced attention heads lowers memory consumption and energy usage, thereby increasing processing speed and enabling real-time analysis. The integration of anomaly detection based on local communication history further improves precision, lowering false alarms compared to simple keyword-based filters.

The server uses the generative AI model not as a mere content generator, but as a component in a supervised learning pipeline that automatically produces training data and rule candidates.

The server applies explicit post-processing and evaluation steps, including labeling, filtering, and integration with real datasets, and uses this curated data to train discriminative models.

This arrangement constitutes a technical improvement over human-only rule creation because it scales to greater pattern variety and can react faster to new threats while maintaining model quality and terminal compatibility. The specific configuration of prompt sentences and the structured interpretation of generative outputs produce machine-readable patterns and constraints that are not naturally produced by human operators at the same speed or volume.

In other embodiments, the terminal can implement different neural architectures, such as a bidirectional recurrent neural network with attention or a convolutional neural network for short-text classification, provided that the model accepts tokenized character information as input and outputs a risk value. In another variation, the terminal can use separate language-specific models that are selected by the language determination processing module. In yet another embodiment, the server can employ different generative AI models with different sampling strategies, temperature parameters, and decoding algorithms to control diversity and quality of generated examples.

In all embodiments, the server and the terminal cooperate so that generative AI capabilities are integrated into a structured detection system, and the terminal performs low-latency, on-device risk evaluation with a combination of rule-based and statistical algorithms. This cooperation yields technical effects such as reduced network overhead, improved classification accuracy, faster adaptation to new fraud patterns, and stronger privacy guarantees compared to systems that transmit raw communication data to remote servers or rely solely on static rule sets.

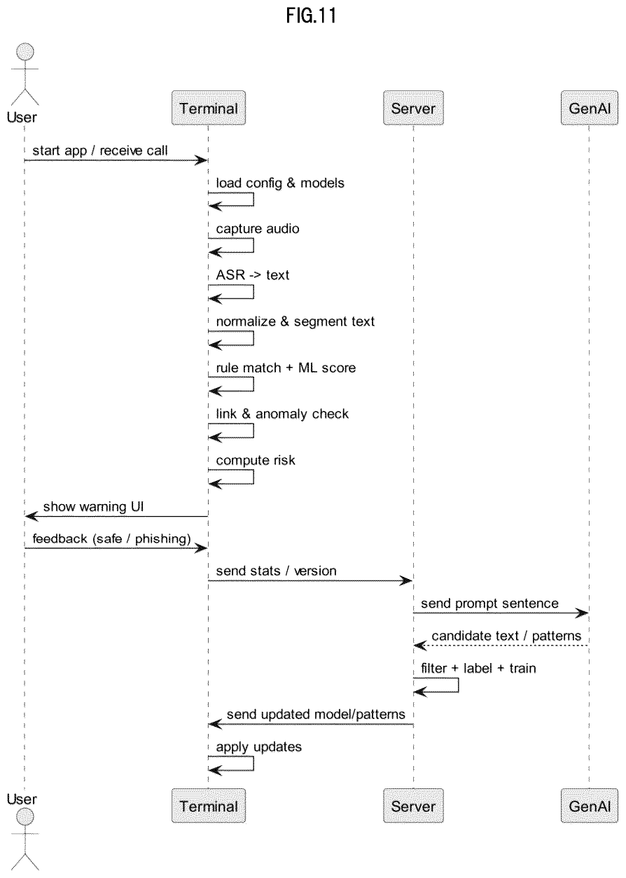

The following describes the processing flow using FIG. 11.

### Step 1:

The terminal initializes a phishing-detection application and loads configuration data.

The terminal receives, as input, system configuration files, model parameter files, phrase pattern information, and destination information pattern information from local storage. The terminal parses these files, verifies version identifiers, and allocates memory for runtime data structures such as pattern tables, tokenizer vocabulary, and model weights. Based on this input, the terminal constructs in-memory indices for phrase patterns and destination patterns so that subsequent lookups are performed in constant or logarithmic time. The terminal outputs an initialized internal state, including loaded models, pattern tables, and configuration thresholds, which is used by later processing steps.

### Step 2:

The terminal monitors incoming calls and message notifications.

The terminal receives, as input, event signals from the operating system indicating call state changes and new message arrivals. For a call, the terminal acquires metadata such as caller identifier and call type. For a message, the terminal acquires basic metadata such as message identifier and application identifier. The terminal updates an internal event queue by enqueuing a “call session” object or a “message session” object for each detected communication. The terminal outputs a structured event list that represents pending communications to be analyzed.

### Step 3:

The terminal captures audio information for active calls and prepares it for recognition.

The terminal receives, as input, a call session object and a continuous audio stream from the microphone or telephony subsystem. The terminal samples the audio at a specified sampling rate and buffers it into fixed-length frames (for example, 20-30 ms per frame). The terminal performs data processing including high-pass filtering, amplitude normalization, noise suppression, and echo cancellation on each frame. The terminal computes spectral features such as Mel-frequency cepstral coefficients or log-mel spectrograms, resulting in a feature matrix for each time window. The terminal outputs processed audio feature sequences that are suitable as input to the speech recognition model.

### Step 4:

The terminal converts processed audio features into character information by speech recognition.

The terminal receives, as input, audio feature sequences from Step 3. The terminal feeds these sequences into an acoustic model implemented as a neural network, such as a stack of convolutional layers followed by recurrent or transformer layers. The terminal performs matrix multiplications and non-linear activations to compute posterior probabilities over phonetic units or subword tokens. The terminal then applies a decoding algorithm, such as beam search with a language model, to transform these probabilities into text hypotheses. The terminal concatenates hypotheses into character information representing the recognized utterances and segments them by time boundaries. The terminal outputs a stream of character information aligned with the call timeline.

### Step 5:

The terminal normalizes and segments the character information.

The terminal receives, as input, raw character information from Step 4. The terminal executes language determination by computing character frequency vectors and applying a lightweight classifier to assign a language label to each segment. The terminal then applies language-specific normalization rules, such as converting full-width characters to half-width characters, transforming uppercase to lowercase where appropriate, standardizing punctuation, and removing repeated filler tokens. The terminal detects sentence boundaries using punctuation marks and prosodic cues mapped from audio timing information. The terminal structures the normalized text into an ordered list of sentences, each tagged with language and time indices. The terminal outputs normalized, sentence-level character information ready for analysis.

### Step 6:

The terminal performs rule-based phrase pattern matching on the character information.

The terminal receives, as input, the normalized sentence list from Step 5 and the phrase pattern information loaded in Step 1. For each sentence, the terminal tokenizes the sentence into words or subwords, then iterates over pattern entries that match the language label. The terminal applies matching operations using exact string match, regular expressions, or finite-state automata to detect occurrences of suspicious phrase patterns. The terminal calculates a rule score by summing severity values associated with matched patterns and records which patterns fired, along with sentence indices. The terminal outputs a rule-matching result that includes the rule score, the list of triggered patterns, and references to the corresponding sentence fragments.

### Step 7:

The terminal analyzes message information, including subject, body, sender, and links.

The terminal receives, as input, a message session object from Step 2 and raw message data from a messaging application interface, including subject information, body information, sender information, and link information. The terminal parses the message to extract plain text from headers and body, removes markup where appropriate, and builds a message document object containing text fields and a list of extracted links. For each link, the terminal parses the destination string into protocol, domain, subdomain, top-level domain, path segments, and query parameters. The terminal outputs a structured message representation including tokenized text and decomposed destination components.

### Step 8:

The terminal executes rule-based destination information pattern matching on links.

The terminal receives, as input, destination components from Step 7 and destination information pattern information from Step 1. The terminal applies pattern rules that encode structural constraints, such as maximum subdomain depth, presence of confusing homograph characters, or forbidden domain suffixes. For each destination, the terminal checks conditions like character-class distributions, length thresholds, and similarity to known trusted domains using string distance metrics. The terminal assigns a destination rule score for each suspicious link and labels the link as suspicious when a threshold is exceeded. The terminal outputs an aggregated link analysis result, including destination rule scores and flags for suspicious links.

### Step 9:

The terminal computes a machine-learning-based risk value from text content.

The terminal receives, as input, the normalized character information from Step 5 and the structured message text from Step 7. The terminal applies a tokenizer associated with the machine learning model to map subwords in each sentence or message to token identifiers. The terminal groups token identifiers into sequences with special classification tokens and attention masks, and feeds them into a compact transformer classifier loaded from local storage. The terminal performs attention and feed-forward operations layer by layer, using stored weight matrices and bias vectors, to compute contextual embeddings. The terminal then passes the embedding of the classification token through a classification head consisting of linear layers and a softmax or sigmoid function to obtain a probability that the communication is fraudulent. The terminal outputs a machine-learning-based risk value in the range [0,1] for each analyzed text object.

### Step 10:

The terminal calculates an anomaly-based abnormality degree using communication history.

The terminal receives, as input, features extracted from the current call or message (such as sender identity, call duration, topic distribution, time-of-day) and communication history information stored locally. The terminal computes distributions of historical features, such as frequency of a given sender, typical word distributions, and usual time-of-day patterns, and represents them as statistical profiles. The terminal then calculates distance metrics between current features and historical profiles, such as cosine distance between topic vectors or divergence between sender frequency distributions. The terminal aggregates these distances into a scalar abnormality degree using a weighted combination. The terminal outputs the abnormality degree representing how unusual the current communication is relative to the user's usual pattern.

### Step 11:

The terminal integrates rule scores, machine-learning-based risk values, and abnormality degrees into a risk evaluation value.

The terminal receives, as input, the rule-matching result from Step 6, the link analysis result from Step 8, the machine-learning-based risk value from Step 9, and the abnormality degree from Step 10. The terminal retrieves weighting information and thresholds from configuration data. The terminal computes a combined score by applying a weighted sum or non-linear function, for example: combined_score=w1×rule_score+w2×ml_risk+w3×abnormality+w4×link_score. The terminal may also apply calibration parameters obtained from server-provided models. The terminal compares the combined score with one or more thresholds to classify the communication as safe, suspicious, or high-risk. The terminal outputs a risk evaluation value and a classification label for the communication instance.

### Step 12:

The terminal generates and presents warning information based on the risk evaluation value.

The terminal receives, as input, the risk evaluation value and classification label from Step 11 and the list of triggered phrase patterns and suspicious links. When the classification label indicates suspicious or high-risk, the terminal constructs warning information that includes a summary of the risk level, a list of important triggering phrases (for example, “verify your account,” “provide your password”), and a list of suspicious links with their domains redacted or highlighted. The terminal selects concrete avoidance actions, such as “Do not disclose any personal information during this call,” or “Do not tap the following links.” The terminal sends this warning information to the user interface subsystem, which displays a popup or overlay and may trigger an audible alert. The terminal also presents operation means such as buttons “End call,” “Delete message,” and “Mark as safe.” The terminal outputs both the user-facing warning display and an internal state indicating that the communication has been flagged.

### Step 13:

The terminal captures user feedback from operation means and updates local parameters.

The terminal receives, as input, operation content generated when the user interacts with the warning interface, such as selecting “Mark as safe” or “Report as phishing.” The terminal interprets this feedback as either a confirmation or a rejection of the system's classification. Based on this input, the terminal updates local thresholds and weighting parameters, for example by slightly lowering sensitivity if many safe communications were flagged or increasing sensitivity for certain patterns confirmed as phishing. The terminal records this feedback in local storage as part of communication history. The terminal outputs updated configuration values and enriched history data that will influence future risk calculations.

### Step 14:

The server manages pattern information, machine learning models, and feedback received from terminals.

The server receives, as input, feedback information from multiple terminals, including statistics on false positives and false negatives, anonymized pattern usage, and model version identifiers, as allowed by configuration. The server updates a central database of phrase pattern information and destination information pattern information based on this feedback and on external threat intelligence feeds. The server computes summary metrics that indicate which patterns are effective or outdated and identifies gaps where existing models underperform. The server outputs revised pattern sets and a list of requirements for new training data and model updates.

### Step 15:

The server uses a generative AI model with prompt sentences to generate candidate training data and rules.

The server receives, as input, requirements for new patterns and training examples from Step 14. The server constructs one or more prompt sentences that describe desired phishing scenarios, languages, and subtlety levels. Example prompt sentences include:
“Generate realistic phishing phone call scripts where an attacker impersonates a bank and attempts to obtain account numbers and one-time passwords.”
“Generate multilingual phishing emails that instruct users to click a link to verify their accounts due to alleged suspicious activity.”
“Propose linguistic patterns and sentence structures that indicate a hidden request for sensitive information without using obvious trigger words.”

The server submits these prompt sentences to the generative AI model and receives generated text as candidate information. The server parses and segments the generated text into sentence examples, phrase candidate patterns, and rule proposals. The server outputs a structured set of labeled candidates for further processing.

### Step 16:

The server filters, labels, and uses generated candidates to train or update the machine learning model.

The server receives, as input, the structured candidate set from Step 15 and the existing corpus of legitimate and fraudulent communications. The server filters out low-quality or redundant candidates by applying criteria such as similarity thresholds and length constraints. The server assigns labels to remaining candidates (for example, “fraudulent” or “benign”) and merges them into an extended training dataset. The server then trains or fine-tunes the machine learning model by performing iterative optimization: feeding batches of tokenized text into the network, computing loss values such as cross-entropy between predicted probabilities and true labels, and updating weights by gradient descent and backpropagation. The server outputs updated model parameters and updated pattern tables that reflect newly learned fraudulent behaviors.

### Step 17:

The server packages update information and distributes it to terminals.

The server receives, as input, the updated machine learning model parameters and pattern tables from Step 16 and current versioning information for each terminal type. The server compresses the model using techniques such as quantization or pruning to meet device constraints, then packages the compressed model together with updated phrase pattern information, destination information pattern information, and configuration settings into versioned update information. The server exposes this update information via a secure API and responds to update requests from terminals with this data. The server outputs update payloads customized for terminal capabilities.

### Step 18:

The terminal acquires update information from the server and refreshes local detection components.

The terminal receives, as input, update payloads from the server obtained over a secure communication channel. The terminal verifies integrity and authenticity of the payloads, for example using checksums and digital signatures. Upon successful verification, the terminal writes new model parameters and updated pattern tables into local storage and replaces in-memory structures, such as embedding matrices and pattern indices, with updated versions. The terminal may schedule these changes to take effect after current sessions finish to avoid disruption. The terminal outputs refreshed detection components that will be used for subsequent calls and messages, thereby improving detection accuracy and maintaining up-to-date protection.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented threat detection systems that process audio and text information typically rely on static rule sets or fixed machine learning models deployed on a server or on user devices. Such systems suffer from several technical problems in terms of computer technology itself. First, these systems often combine heterogeneous signals, such as speech-recognition output, contextual text features, and anomaly scores, in an ad-hoc manner, which leads to inefficient use of processor and memory resources and unstable detection accuracy under changing acoustic environments. Second, existing systems generally lack an integrated feedback loop that uses structured user responses and historical incidents to automatically adjust model parameters, processing thresholds, and decision rules, resulting in degraded performance of the overall computing pipeline over time and requiring manual, error-prone reconfiguration by administrators. Third, when generative AI models are used, they are often invoked in an unstructured, offline way; prompt sentences are not systematically constructed from machine-readable diagnostics, and the output of the generative AI model is not safely transformed into configuration changes that can be deployed in a controlled manner, which prevents effective, reproducible improvement of the computational detection pipeline.

As a result, processors executing such detection workloads may exhibit increased latency, excessive false positives or false negatives, and inefficient use of network bandwidth when distributing models and settings across multiple devices. Furthermore, without a unified mechanism to generate and apply machine-readable proposals from a generative AI model, it is difficult for a computer system to continuously optimize internal processing conditions, decision thresholds, and warning generation logic in response to actual operating data. Accordingly, there is a need for a computer-implemented technique that configures a processor to (i) acquire and pre-process acoustic information, perform speech recognition, and derive structured language features; (ii) compute a unified threat risk index by weighted synthesis of keyword-based scores, emotion-based urgency, and anomaly metrics; and (iii) automatically construct structured prompt sentences for a generative AI model from performance information, obtain proposal information in return, and safely apply the proposal information as staged updates to processing conditions and thresholds distributed across multiple devices. Such a technique should improve the technical performance of the threat detection pipeline itself, including accuracy, adaptability, and resource efficiency of the underlying computing system.

The specific processing by the specific processing unit 290 of the data processing device 12 in Application Example 1 is realized by the following means.

The present invention provides a server comprising a processor configured to acquire acoustic information from an acoustic acquisition apparatus, perform pre-processing on the acoustic information to generate acoustic features, perform speech recognition processing on the acoustic information to generate character information, execute language information analysis processing on the character information including extraction of expressions, analysis of context, estimation of emotion, and calculation of abnormality, calculate a threat risk index based on a weighted combination of a keyword-based score, an emotion-based urgency degree, and the abnormality, generate warning information based on the threat risk index, transmit the warning information to a portable information terminal, receive response information from the portable information terminal, update and record an event state according to the response information, generate a learning information set based on past event records and the response information, update processing conditions or decision thresholds used for classification processing or anomaly detection processing in the language information analysis processing based on the learning information set, construct a structured prompt sentence for a generative AI model based on performance information including detection results of the server, false detection cases, and missed detection cases, transmit the structured prompt sentence to the generative AI model, obtain proposal information from the generative AI model, store the proposal information as setting information, and, in response to an approval operation by an administrator, update in stages at least one of the processing conditions, the decision thresholds, and a warning information generation rule, and distribute the updated processing conditions or the decision thresholds to a plurality of acoustic acquisition apparatuses and portable information terminals. This enables the computer system to automatically refine and redeploy its internal detection logic and parameter settings based on real-world performance data, thereby improving the technical operation of the server in terms of detection accuracy, adaptability to changing environments, processing efficiency, and coordinated configuration management across multiple devices.

The term “acoustic information” refers to digital data representing sound signals captured from an environment, including but not limited to voice, background noise, and abnormal sounds, in a time-series format suitable for computer processing.
The term “acoustic acquisition apparatus” refers to an electronic device configured to capture sound from a physical space and convert the sound into acoustic information, such as a microphone unit, an array of microphones, or an audio sensor module.
The term “pre-processing” refers to a series of computational operations performed on raw acoustic information to improve its quality or suitability for subsequent analysis, including at least one of noise reduction, filtering, segmentation, normalization, and feature extraction.
The term “acoustic features” refers to numerical representations derived from acoustic information, such as spectral coefficients, energy values, or other signal descriptors, that are used as inputs to speech recognition or other analysis algorithms.
The term “speech recognition processing” refers to computer-implemented processing that converts acoustic information or acoustic features into character information, using pattern recognition or machine learning techniques to identify linguistic content.
The term “character information” refers to text data, encoded as a sequence of characters or symbols, representing the linguistic content of speech obtained from speech recognition processing.
The term “language information analysis processing” refers to a set of computational operations performed on character information, including at least expression extraction, context analysis, emotion estimation, and abnormality calculation, to derive structured indicators related to potential threats.
The term “extraction of expressions” refers to processing that identifies words, phrases, or other linguistic units of interest from character information, including tokens, n-grams, or named entities relevant to threat detection.
The term “analysis of context” refers to processing that interprets the meaning or intent of character information based on surrounding words, sentence structure, or situational attributes, beyond simple keyword matching.
The term “estimation of emotion” refers to processing that infers an emotional state or affective tone, such as fear, anger, or calmness, from character information or related features, and outputs an emotion label or an emotion-related score.
The term “calculation of abnormality” refers to processing that evaluates how much a given instance of character information deviates from typical or learned patterns of non-threat communication, and outputs an abnormality metric or score.
The term “threat risk index” refers to a numerical or categorical indicator computed based on at least a keyword-based score, an emotion-based urgency degree, and an abnormality metric, representing the overall estimated likelihood or severity of a threat.
The term “keyword-based score” refers to a numerical value derived from the presence, frequency, or combination of specific words or phrases in character information that are associated with threat or non-threat situations.
The term “emotion-based urgency degree” refers to a numerical value indicating the urgency or criticality of a situation as inferred from estimated emotion, such as increased weight for panic or fear states.
The term “anomaly detection processing” refers to a computational technique that determines whether a given data instance is normal or abnormal with respect to a learned distribution or model of past data, and produces an abnormality score.
The term “warning information” refers to data describing a detected or potential threat, including at least a threat risk index, a priority or urgency level, and contextual information such as time and location, which is generated for notification.
The term “portable information terminal” refers to a user-carried electronic device capable of wireless communication and user interaction, such as a handheld terminal, mobile communication device, or portable computing apparatus.
The term “response information” refers to data transmitted from a portable information terminal to indicate a user's reaction to warning information, including acknowledgements, action selections, or status updates.
The term “event state” refers to information indicating a current or historical status of an incident or detection event, including stages such as open, acknowledged, in-progress, or resolved, along with associated metadata.
The term “event record” refers to a stored data structure that logs details of a detection event, including character information, analysis results, warning information, event state, and any associated response information.
The term “learning information set” refers to a collection of structured data derived from event records and response information, prepared for use in training, updating, or validating classification or anomaly detection models.
The term “processing conditions” refers to parameters, configuration values, or control logic that determine how analysis, classification, anomaly detection, or warning generation algorithms operate within the system.
The term “decision thresholds” refers to numerical boundary values used by a processor to determine when to change states, raise warnings, or classify an event into different risk or priority levels.
The term “generative AI model” refers to a generative information processing model, such as a machine learning or neural network model, configured to generate text, rules, or other structured outputs in response to input prompt sentences.
The term “prompt sentence” refers to a structured textual input, possibly including formatted data or examples, constructed for submission to a generative AI model to request proposals, rules, or configuration suggestions.
The term “performance information” refers to data describing operational behavior of the system, including detection results, false detection cases, missed detection cases, and other metrics indicating the effectiveness of processing.
The term “proposal information” refers to output generated by a generative AI model in response to a prompt sentence, including suggested changes to processing conditions, decision thresholds, feature definitions, or warning generation rules.
The term “setting information” refers to stored configuration data representing applied or candidate processing conditions, decision thresholds, or rules, including those derived from proposal information.
The term “approval operation” refers to an explicit user action, performed by an administrator or authorized operator via a user interface, that authorizes the system to apply or update specific processing conditions or decision thresholds.
The term “warning information generation rule” refers to logic or criteria that specify how and under what circumstances warning information is generated, including mapping from threat risk indices to warning types and priorities.
The term “management processing” refers to processing performed by the server to distribute, synchronize, and control processing conditions, decision thresholds, and related configuration data across multiple devices in the system.

In one embodiment, a server, a plurality of terminals, and a plurality of acoustic acquisition apparatuses cooperate to implement the present invention. The server includes at least one processor, a memory, a storage device, and a network interface. The terminals include portable information terminals carried by security staff, such as handheld devices or mobile communication devices, each having a processor, a memory, a display, an input interface, and a wireless communication module. The acoustic acquisition apparatuses include microphones or microphone arrays installed in a monitoring target area such as a building, a transportation facility, or an industrial plant. The microphones are connected either directly to the server through a wired or wireless network, or indirectly through an edge device such as an embedded computing module.

Server executes an operating system such as a server-class general-purpose operating system and runs middleware including an audio processing library (for example, a generic audio I/O framework), a numerical computation library (for example, a general matrix and vector library), and a machine learning framework (for example, a neural network framework).

Server further executes a language processing library implementing tokenization, sentence segmentation, and transformer-based encoding of text. In some embodiments, server executes a speech recognition engine implementing an encoder-decoder neural network similar to a sequence-to-sequence model with an attention mechanism, trained for multilingual speech recognition. In other embodiments, server executes a hybrid model including convolutional layers and recurrent layers for acoustic modeling and a separate language model component.

Server receives acoustic information from each acoustic acquisition apparatus. Acoustic information is stored in a circular buffer in memory as time-stamped frames of digital samples, for example, 16-bit linear pulse code modulation samples at a sampling rate suitable for voice analysis. Server applies pre-processing on the acoustic information using a digital signal processing pipeline. Server computes short-time Fourier transforms to obtain spectral representations, applies spectral subtraction or Wiener filtering to reduce stationary background noise, and applies band-pass filtering to emphasize human speech frequencies.

Server then derives acoustic features such as Mel-frequency cepstral coefficients, log-Mel filterbank energies, and delta features, and stores these features in a feature matrix data structure associated with a session identifier and location identifier.

Server performs speech recognition processing on the acoustic features. In one embodiment, server loads a neural network acoustic model composed of multiple layers of convolutional units followed by self-attention blocks and feed-forward layers. Server feeds the acoustic feature sequence into the acoustic model to obtain a sequence of probability distributions over sub-word units or phonetic units. Server then applies a decoding algorithm such as beam search or connectionist temporal classification decoding, optionally combined with an external language model, to generate character information as a sequence of Unicode characters. Server associates the character information with metadata including time, location, and acoustic acquisition apparatus identifier, and stores the character information in a text record table of a relational database.

Server executes language information analysis processing on the character information.

Server first performs expression extraction by tokenizing the character information into words or sub-word tokens, generating n-grams, and identifying candidate expressions using a dictionary of risk-related terms. Server then performs context analysis by mapping the token sequence into context vectors using a transformer-based encoder model that includes multiple self-attention layers, layer normalization, and position-wise feed-forward networks. Server inputs the context vectors into a classification head implemented as one or more fully connected layers to output logits for different semantic categories, including threat-related categories and non-threat categories.

Server performs estimation of emotion by using a neural network model trained for emotion recognition. In one embodiment, server uses the same transformer encoder to obtain sentence-level embeddings, and a separate emotion classifier head outputs a probability distribution over emotion labels such as fear, anger, panic, and neutral. Server computes an emotion-based urgency degree by mapping the emotion probabilities to a scalar value, for example by weighting panic and fear more heavily than neutral or calm states.

Server performs calculation of abnormality by executing anomaly detection processing on feature vectors that integrate textual, temporal, and spatial attributes. Server constructs a feature vector including elements such as a sentence embedding, a one-hot or embedded representation of location, time-of-day features, and the emotion-based urgency degree. In one embodiment, server applies an isolation-based algorithm that partitions the feature space using random splits and measures how easily a sample can be isolated, thereby generating an abnormality score. In another embodiment, server uses an autoencoder neural network that encodes the feature vector into a low-dimensional representation and decodes it back; server computes the reconstruction error as the abnormality metric.

Server calculates a threat risk index by combining a keyword-based score, the emotion-based urgency degree, and the abnormality metric. Server stores the keyword-based score and the emotion-based urgency degree in dedicated fields, and then computes the threat risk index as a weighted sum or a non-linear function implemented in software, using coefficients stored in configuration parameters. These coefficients may be different for different locations or times of day and can be updated as part of the learning process described below. By representing the threat risk as a single computed index, server can efficiently compare the index against multiple thresholds using simple arithmetic operations, reducing processing time compared to executing separate rule evaluations at run time.

Server generates warning information based on the calculated threat risk index. Server compares the threat risk index with one or more decision thresholds to determine whether to generate a warning and, if so, with what priority. Server constructs warning information as a structured data object including the threat risk index, a priority label, the associated character information, the emotion estimation result, and the event state. Server writes the warning information into an incident record and sends a subset of the information to terminals via network communication.

Terminal receives the warning information through a network interface that supports push notification, persistent connection, or polling. Terminal stores the received warning information in a local data structure and displays key elements such as the priority, location, and a short text summary on a display. Terminal presents selectable user interface elements such as buttons for acknowledgement, dispatch, or marking an event as a false alarm. Terminal records user input as response information and transmits the response information back to server over a secure communication channel.

Server updates an event state based on the response information received from terminals.

Server modifies fields such as state, timestamp of last action, and responsible user in the event record. Server logs all state changes in an audit table, linking each change to underlying warning information, the character information, and the acoustic information. These audit records form part of a learning information set.

Server periodically or on demand constructs a learning information set from past event records and associated response information. Server extracts elements such as the character information, the threat risk index, the underlying component scores, and the final human-confirmed labels (for example, true threat or false alarm). Server stores these elements in a training dataset structure, such as a matrix of feature vectors and a corresponding label vector, or in a serialized dataset format suitable for input to the machine learning framework.

Server may apply data augmentation, such as random perturbation of non-critical features or generation of paraphrased text using a data augmentation technique, to improve generalization of the models.

Server updates processing conditions and decision thresholds used for classification processing and anomaly detection processing based on the learning information set. In one embodiment, server fine-tunes the neural network models by performing supervised learning on the training dataset. Server defines a loss function that combines cross-entropy loss for threat classification, cross-entropy loss for emotion classification, and a regularization term for the anomaly detection model. Server computes gradients of the loss function with respect to model parameters using backpropagation, and updates the parameters using an optimization algorithm such as stochastic gradient descent with adaptive learning rates. Server logs training metrics such as loss, accuracy, and F1-scores and selects model versions that satisfy predefined performance criteria. Server then updates processing conditions, including model parameters and feature selection configurations, and adjusts decision thresholds based on analysis of the distribution of threat risk indices in the validation data.

Server constructs a prompt sentence for a generative AI model based on performance information, including detection results, false detection cases, and missed detection cases.

Server aggregates performance statistics such as confusion matrices, distributions of threat risk indices for true threats and false alarms, and time-based trends in errors. Server formats these statistics and representative examples into structured narrative text. For example, server may create a prompt sentence such as:
“Design improved threat detection rules for a multilingual speech-based security system. Our current system uses speech recognition, a transformer-based text classifier, emotion estimation, and anomaly detection. We frequently misclassify loud but harmless conversations as high threat, and we sometimes miss low-volume distress phrases such as ‘help’ spoken quietly. Propose changes to feature extraction, model architecture, and decision rules to reduce false positives while maintaining recall.”
   In another example, server may create a prompt sentence:
“Given the following labeled transcripts with their threat risk indices and final human labels, propose new weighted combinations of keyword-based scores, emotion-based urgency degrees, and abnormality metrics, and suggest additional conditions under which warnings should be suppressed or escalated.”

Server transmits the constructed prompt sentence to a generative AI model residing either on the same server or on a remote computational resource. The generative AI model may be implemented as a large-scale transformer network trained for conditional text generation.

Server receives proposal information generated by the generative AI model and parses the proposal information to extract candidate processing conditions, modifications to decision thresholds, or changes to warning generation rules. Server stores the proposal information as setting information in a configuration database.

User, acting as an administrator, accesses an administrative interface provided by server, for example, via a web-based dashboard on a terminal. Server presents the proposal information as human-readable rules, parameter suggestions, or descriptions of architectural changes. User reviews the proposals and performs an approval operation to select which proposals should be applied. Server, in response to the approval operation, updates processing conditions or decision thresholds in a staged manner. For example, server may initially apply a new set of thresholds only to a subset of monitoring locations and evaluate resulting performance before rolling out the thresholds system-wide. Server distributes updated processing conditions and thresholds to acoustic acquisition apparatuses and terminals by sending configuration messages through the network. The acoustic acquisition apparatuses may adjust local pre-processing parameters, such as sensitivity to background noise, while terminals may adjust local display preferences or filtering of low-priority warnings.

This configuration yields a technical effect that goes beyond mere automation of human judgment. Server coordinates multiple specialized models and rule sets in a unified data flow, carefully managing feature representations and model interactions to optimize performance on a computing platform. By integrating keyword-based scoring, emotion-based urgency estimation, and anomaly detection into a single threat risk index, server reduces redundant computations and simplifies threshold comparison, thereby improving processing speed. Moreover, by using a learning information set and proposal information from a generative AI model to adjust parameters and rules, server achieves an adaptive system that can maintain high detection accuracy under changing acoustic and linguistic conditions without requiring manual reprogramming for each scenario.

Server improves computational efficiency and data management by using explicit data structures for acoustic features, text records, event records, and learning datasets, and by controlling when and how models are retrained and deployed. Server can schedule training tasks outside peak monitoring times to avoid impacting real-time detection latency. Server also reduces communication load by distributing only compact processing conditions and thresholds to devices, rather than streaming raw or full intermediate data, which is particularly beneficial in large installations with many acoustic acquisition apparatuses and terminals.

The described embodiments represent only some of the possible configurations. In alternative embodiments, server may deploy different neural network architectures, such as recurrent neural networks with gated units or convolutional networks with temporal pooling, for speech recognition or language analysis. Server may also adopt different anomaly detection techniques, such as density-based methods or clustering-based methods, as long as an abnormality metric is computed and incorporated into the threat risk index. Terminals may be implemented as fixed display units instead of portable devices, and acoustic acquisition apparatuses may include video sensors providing additional modalities, in which case server may extend the feature vectors to include visual features as well.

In all these embodiments, server, terminal, and user cooperate through explicit data flows and configuration mechanisms to realize a system that not only processes acoustic and textual information but also continuously improves its internal computational pipeline, thereby enhancing detection accuracy, processing efficiency, and robustness in real-world monitoring environments.

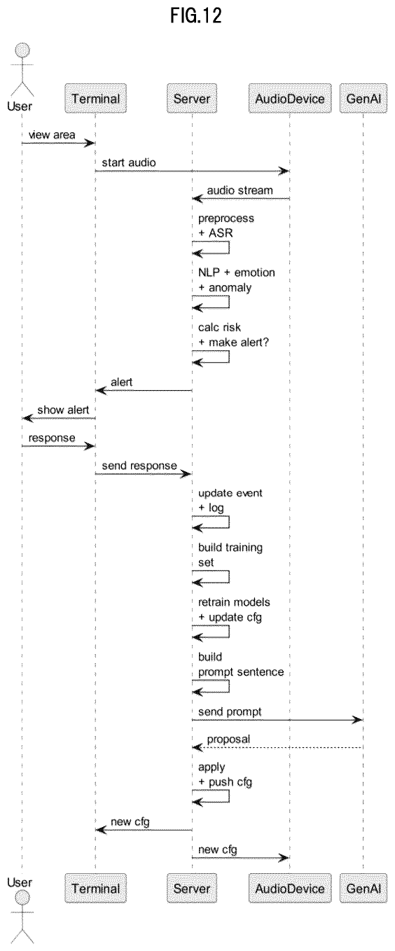

The following describes the processing flow using FIG. 12.

### Step 1:

Server receives acoustic information from acoustic acquisition apparatuses.

Server uses a network interface to accept incoming digital audio streams as time-stamped frames (input: raw PCM samples and device identifiers). Server performs buffering and converts the incoming byte streams into an internal frame structure including fields for sample array, timestamp, and location ID. Based on these inputs, Server stores the frames in a circular buffer in memory as the output of this step.

### Step 2:

Server performs pre-processing on the acoustic information.

Server reads buffered frames (input: raw PCM frames with timestamps and location IDs) and applies digital signal processing operations, including short-time Fourier transform, spectral subtraction, and band-pass filtering. Server then computes acoustic features such as spectral energies and cepstral coefficients from the transformed signals. Based on this processing, Server outputs a feature matrix for each time window, together with metadata linking the feature matrix to the original timestamp and location.

### Step 3:

Server executes speech recognition processing to generate character information.

Server takes as input the feature matrices and associated metadata from Step 2. Server feeds the feature matrices into a neural network acoustic model and calculates probability distributions over symbol units for each time step. Server then runs a decoding algorithm to convert the symbol probabilities into a sequence of characters. Server outputs character information (recognized text) and attaches the timestamp, location, and confidence scores as part of a text record.

### Step 4:

Server performs expression extraction on the character information.

Server receives as input the text records from Step 3. Server tokenizes each text string into words or sub-word units and generates n-grams. Server compares the tokens and n-grams against a dictionary of risk-related expressions and assigns a keyword-based score according to matched entries. Server outputs an enriched text record including the token list, matched expressions, and the keyword-based score.

### Step 5:

Server executes context analysis on the character information.

Server takes as input the enriched text records from Step 4. Server converts each token sequence into numerical embeddings using a transformer-based encoder, then propagates the embeddings through the encoder layers to obtain context vectors. Server applies a classification head to the context vectors to compute class probabilities for threat-related categories. Based on these probabilities, Server outputs a context analysis result that includes a threat class prediction and associated confidence, linked to the original text record.

### Step 6:

Server performs estimation of emotion from the character information.

Server receives as input the context vectors or sentence embeddings from Step 5 and the original text. Server passes these inputs into an emotion classifier model, which computes a probability distribution over emotion labels. Server then calculates an emotion-based urgency degree by weighting specific emotion probabilities, such as panic or fear, more heavily than neutral. Server outputs an emotion analysis record containing the dominant emotion label and the urgency degree.

### Step 7:

Server executes anomaly detection processing on integrated feature vectors.

Server takes as input the character information, the context analysis result, the emotion analysis record, and environmental meta-information such as time of day and location ID. Server constructs a feature vector that concatenates a sentence embedding, a location encoding, a time encoding, the keyword-based score, and the emotion-based urgency degree. Server feeds this feature vector into an anomaly detection model, computes an abnormality score based on reconstruction error or isolation depth, and outputs an anomaly analysis record containing the abnormality score and a flag indicating whether the instance is normal or abnormal.

### Step 8:

Server calculates a threat risk index from component scores.

Server receives as input the keyword-based score from Step 4, the emotion-based urgency degree from Step 6, and the abnormality score from Step 7. Server performs a weighted arithmetic operation or a predefined non-linear mapping to combine these three components into a single threat risk index. Server stores the calculated threat risk index in an incident candidate record and outputs the incident candidate record including all intermediate scores.

### Step 9:

Server generates warning information based on the threat risk index.

Server takes as input the incident candidate record from Step 8. Server compares the threat risk index against one or more decision thresholds stored in configuration data, and determines a warning priority or decides that no warning is required. When a threshold is exceeded, Server constructs warning information that includes the threat risk index, the priority label, the character information, the location, and the current event state. Server outputs a warning message object and stores it in an incident record in a database.

### Step 10:

Server transmits warning information to terminals.

Server uses the warning message object and incident record from Step 9 as input. Server formats the warning information into a compact payload, such as a JSON structure, suitable for network transmission. Server selects target terminals based on location or assignment and sends the payload across a network connection using push notifications or persistent communication channels. Server outputs a delivery status for each terminal and updates the incident record with transmission results.

### Step 11:

Terminal receives and displays warning information.

Terminal accepts as input the warning payload transmitted by Server in Step 10. Terminal parses the payload to extract fields such as priority, location, short text summary, and incident identifier. Terminal stores these fields in local memory and renders them on a display, optionally playing an alert sound or activating vibration. Terminal outputs a visual representation of the warning and a pending state awaiting user interaction.

### Step 12:

User inputs response information through the terminal.

User observes the displayed warning on the Terminal and provides input via a user interface, for example by selecting buttons corresponding to acknowledgement, dispatch, or false alarm. Terminal takes as input the user's selection and the incident identifier shown on the screen. Terminal combines the selection with user identification data to form response information and outputs this response information as a structured message destined for Server.

### Step 13:

Terminal transmits response information to the server.

Terminal uses the response message constructed in Step 12 as input. Terminal opens or reuses a secure network connection and sends the response message to a predefined endpoint on Server. Terminal may receive an acknowledgement of receipt from Server and updates its local incident display accordingly. Terminal outputs a transmission status and a locally updated incident state, such as “acknowledged” or “resolved”.

### Step 14:

Server updates event state and logs response information.

Server receives as input the response message from Terminal in Step 13. Server validates the user identity and incident identifier, then retrieves the corresponding incident record from storage. Server updates the event state based on the response type and records a timestamped entry in an audit log that links the response information to the incident record. Server outputs an updated incident record and an updated audit log entry, which are stored for future reference and learning.

### Step 15:

Server constructs a learning information set from historical data.

Server takes as input multiple incident records, audit log entries, and outcome labels, such as whether an incident was a true threat or a false alarm. Server extracts relevant fields including character information, threat risk indices, component scores, and final human-confirmed labels. Server organizes these data into a structured training dataset, for example as arrays of feature vectors and corresponding labels. Server outputs a learning information set suitable for model training and evaluation.

### Step 16:

Server updates models, processing conditions, and decision thresholds.

Server uses the learning information set from Step 15 as input. Server performs model training or fine-tuning by computing loss functions, gradients, and parameter updates for the threat classifier, the emotion estimator, and the anomaly detector. Server computes new optimal weights and, where applicable, recalculates processing conditions such as feature scaling parameters and decision thresholds based on validation metrics. Server outputs updated model parameters and revised configuration values that will be used for subsequent inference.

### Step 17:

Server constructs a prompt sentence for a generative AI model based on performance information.

Server takes as input performance information derived from the learning information set and operational logs, including detection accuracy, false detection cases, and missed detection cases. Server selects representative examples and statistical summaries and integrates them into a structured narrative. Server composes a prompt sentence that describes the current system configuration, observed problems, and desired improvements, such as: “Design improved threat detection rules for a multilingual speech-based security system. Our current system uses speech recognition, a transformer-based classifier, emotion estimation, and anomaly detection. We frequently misclassify loud but harmless conversations as high threat, and we sometimes miss low-volume distress phrases such as ‘help’ spoken quietly. Propose changes to feature extraction, model architecture, and decision rules to reduce false positives while maintaining recall.” Server outputs the completed prompt sentence as a textual input for the generative AI model.

### Step 18:

Server communicates with the generative AI model and obtains proposal information. Server sends the prompt sentence from Step 17 as input to the generative AI model via an interface such as an application programming interface. Server receives a textual response from the generative AI model containing suggested modifications, such as new weighting rules, additional conditions for suppressing or escalating warnings, and proposed feature engineering techniques. Server parses the response into proposal information, extracting explicit candidate values for processing conditions and decision thresholds. Server outputs structured proposal information ready for review and potential application.

### Step 19:

Server presents proposal information to the user for approval.

Server takes as input the structured proposal information from Step 18. Server generates a human-readable summary of proposed changes and sends this summary to an administrative interface displayed on a Terminal. User reviews the summary and performs an approval or rejection operation for each proposal. Terminal sends the approval decisions to Server. Server combines the approval decisions with the proposal information and outputs a set of approved configuration changes.

### Step 20:

Server applies approved configuration changes and distributes updated settings.

Server receives as input the approved configuration changes from Step 19. Server updates internal configuration data structures, including model selection flags, weighting coefficients, and decision thresholds, according to the approved changes. Server then generates configuration messages containing these updated settings and sends them to acoustic acquisition apparatuses and Terminals over the network. Based on the inputs and data operations in this step, Server outputs a synchronized set of processing conditions and thresholds across the system, which are then used in subsequent executions of Steps 1 through 14.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional phishing-prevention techniques for communication networks, computer systems mainly rely on static, content-based rules or classifiers that inspect text strings, sender identifiers, or fixed patterns embedded in communication data. Such systems are typically configured as one-shot detectors that execute a predetermined classification algorithm and output a binary or scalar phishing indication. This architecture exhibits several technical limitations from the viewpoint of computer technology.

First, the detection pipeline on a user terminal often processes only textual features derived from communication content without incorporating temporally evolving user-state signals. As a result, the processing circuitry in the terminal cannot adapt its decision thresholds or warning timing to dynamic changes in the user's condition during a voice communication. When a user becomes anxious or panicked, conventional systems still execute the same static classification procedure and trigger warnings based solely on content scores. This mismatch between the system's internal decision state and the user's actual condition degrades the usability of the user interface logic and can lead to late or ineffective warnings, thereby reducing the practical effectiveness of the detection algorithm implemented in the terminal.

Second, many existing machine-learning-based phishing detectors are trained offline and then deployed as fixed models. The deployed models and rule sets in the terminals are not continuously improved based on real-world run-time behavior. Even when terminals generate logs, those logs are often stored as unstructured or semi-structured data that are not systematically exploited to refine the detection logic. As a consequence, the server-side computing environment cannot automatically adapt the model parameters and rule sets to new attack patterns or to observed user reactions, and the detection pipeline gradually becomes stale. This leads to an increased rate of false negatives and false positives, which in turn wastes computational resources on unnecessary warnings and fails to prevent emerging phishing techniques.

Third, conventional client-server architectures typically require extensive transfer of raw communication data, including unprocessed voice content or fully detailed text transcripts, to a remote server for analysis. This architecture has two technical drawbacks. On the one hand, it consumes network bandwidth and increases latency, because large volumes of high-resolution audio or text must be transmitted and processed remotely before warnings can be issued. On the other hand, it forces the server to perform heavy-weight analysis on raw data for each individual communication session, which imposes a significant computational burden on server resources and complicates scaling to a large number of users.

Fourth, even when some form of server-side updating is implemented, conventional systems usually employ deterministic, hand-crafted rules or manually tuned thresholds. They lack an automated mechanism by which a server can convert aggregated, anonymized behavioral and emotional patterns into structured detection-rule updates and user-interface message revisions. In particular, conventional systems do not exploit generative AI models in a structured way to synthesize candidate rule sets and warning messages from summarized run-time metadata, nor do they define a closed feedback loop that feeds server-generated improvements back into the terminal-side processing pipeline.

Accordingly, there is a need for an improved computer-implemented phishing-prevention system that: (i) integrates real-time, multimodal analysis of communication content and user emotional state in the terminal to compute adaptive risk levels; (ii) structures terminal-side outputs into anonymized metadata that can be processed at the server with low bandwidth overhead; (iii) uses a generative AI model driven by prompt sentences derived from summary information to automatically propose refinements to fraud-detection logic and warning messages; and (iv) distributes updated pattern information and model parameters back to terminals so that both server-side and terminal-side computation paths are continuously optimized. By addressing these issues, the invention aims to improve the technical functioning of the underlying computer systems, including reduced server load, reduced network usage, more effective utilization of processing resources on the terminal, and improved alignment between warning behavior and user state.

The specific processing by the specific processing unit 290 of the data processing device 12 in Example 2 is realized by the following means.

The present invention provides a server comprising a processor and a storage device, the processor being configured to store, in the storage device, pattern information relating to fraudulent communication, keyword information, scenario information, and parameter information of a natural language processing model, accumulate anonymized metadata received from one or more terminal devices, the anonymized metadata including at least text information derived from communication voice data, emotional state information of a user, risk level information determined in the terminal devices, and behavioral information indicating whether the user has terminated a voice communication, generate summary information on the basis of the anonymized metadata, generate a prompt sentence including at least the summary information and a description of output conditions to be generated, input the prompt sentence and at least part of the summary information into a generative AI model, acquire, from an output of the generative AI model, an improvement proposal relating to at least one of a fraud detection logic and a warning message content, update at least one of the pattern information and the parameter information stored in the storage device on the basis of the improvement proposal, and distribute, through a communication network, at least one of the updated pattern information and the updated parameter information to the one or more terminal devices so that at least one of a voice data processing function, a text data processing function, an emotion analysis function, and an integrated determination function executed in each terminal device is updated. This enables the server and the terminal devices to cooperate in a closed feedback loop in which real-time terminal-side analysis results are compactly summarized and used to drive a generative AI-based optimization process, thereby continuously improving the computational behavior of detection models and warning control logic in the terminal devices while reducing network traffic and server-side processing load compared to systems that operate on raw communication data.

The term “voice data processing function” refers to a function executed by a processor that acquires communication voice data relating to a voice communication, performs at least preprocessing including noise reduction processing and sampling-rate conversion processing on the communication voice data, and converts the preprocessed communication voice data into text information by executing a speech recognition process.
The term “text data processing function” refers to a function executed by a processor that analyzes text information by using at least a natural language processing model and a classification model, determines presence or absence of an expression related to fraudulent communication in the text information, and calculates score information indicating a fraud risk associated with the text information.
The term “emotion analysis function” refers to a function executed by a processor that extracts at least one of acoustic feature information and textual feature information from at least one of communication voice data and text information, and estimates an emotional state of a user and an intensity of the emotional state by using an emotion estimation model.
The term “integrated determination function” refers to a function executed by a processor that determines, on the basis of score information output from a text data processing function and an emotional state output from an emotion analysis function, a risk level of a voice communication from among a plurality of stages, and outputs risk level information.
The term “warning notification function” refers to a function executed by a processor that selects, on the basis of risk level information and an emotional state, a warning message template from among a plurality of warning message templates, controls at least one of a display device and an audio output device so as to present at least one of warning information and caution information to a user, and, in response to an operation input by the user, executes control of a voice communication including at least termination of the voice communication.
The term “pattern storage function” refers to a function executed by a processor that stores, in a storage device, at least pattern information relating to fraudulent communication, keyword information, scenario information, and parameter information of a natural language processing model, and provides the stored information so as to be referable by at least a voice data processing function, a text data processing function, and an integrated determination function.
The term “analysis data management function” refers to a function executed by a processor that accumulates anonymized metadata including at least text information, emotional state information, risk level information, and behavioral information indicating whether a user has terminated a voice communication, and generates summary information on the basis of the anonymized metadata.
The term “analysis enhancement function” refers to a function executed by a processor that generates a prompt sentence including at least summary information and a description of output conditions to be generated, inputs the prompt sentence and at least part of the summary information into a generative AI model, and acquires, from an output of the generative AI model, an improvement proposal relating to at least one of a fraud detection logic and a warning message content.
The term “update processing function” refers to a function executed by a processor that updates at least one of pattern information and parameter information stored in a storage device on the basis of an improvement proposal acquired from a generative AI model.
The term “update distribution function” refers to a function executed by a processor that distributes, through a communication network, at least one of updated pattern information and updated parameter information to one or more terminal devices so that at least one of a voice data processing function, a text data processing function, an emotion analysis function, and an integrated determination function executed in each terminal device is updated.
The term “communication voice data” refers to digital audio data representing voice signals exchanged during a voice communication session performed by a user by using an information processing apparatus.
The term “text information” refers to character-based data obtained by converting communication voice data by a speech recognition process and representing at least part of content of a voice communication.
The term “natural language processing model” refers to a parameterized information processing model, implemented for example as a neural network, that receives tokenized text information as input and outputs at least a representation, label, or probability value for the text information.
The term “classification model” refers to a computational model that receives feature information derived from text information or other data as input and outputs at least a label, class, or score indicating a category such as a fraud risk.
The term “score information” refers to numerical information, such as a probability or scalar value, that indicates a degree of fraud risk associated with a piece of text information or a segment of a communication.
The term “emotional state” refers to information indicating at least one category of emotion of a user, such as calm, anxious, or panicked, and optionally an intensity value representing a strength of the emotion.
The term “emotion estimation model” refers to an information processing model that receives at least one of acoustic feature information and textual feature information and outputs an estimate of an emotional state of a user and an associated intensity.
The term “risk level” refers to information representing a degree of risk that a voice communication is fraudulent, the degree being selected from among a plurality of discrete stages including, for example, a low level, an intermediate level, and a high level.
The term “warning message template” refers to a text pattern including predetermined wording and optionally a placeholder, which is stored in advance and can be selected and filled with contextual information to generate a warning message to be presented to a user.
The term “pattern information” refers to information that represents patterns associated with fraudulent communication, including at least keyword patterns, phrase patterns, and scenario patterns used for detection or evaluation of a fraud risk.
The term “keyword information” refers to information defining one or more words or short expressions that are associated with fraudulent communication and are used as detection cues in text analysis.
The term “scenario information” refers to structured information describing a sequence, structure, or context of communication behaviors that are characteristic of fraudulent communication.
The term “parameter information” refers to numerical or symbolic values defining operating parameters of at least one model, rule, or algorithm, including parameters of a natural language processing model or thresholds used in risk evaluation.
The term “storage device” refers to a hardware unit, such as a semiconductor memory or a magnetic storage medium, configured to store digital information including pattern information, keyword information, scenario information, and parameter information.
The term “anonymized metadata” refers to data derived from communication sessions in which personally identifiable information is removed or masked and which includes at least text-related information, emotional state information, risk level information, and behavioral information usable for analysis and model improvement.
The term “summary information” refers to data that is generated by aggregating or compressing anonymized metadata and that represents characteristic patterns, statistics, or representative cases of communication behavior, emotional states, risk levels, and user actions.
The term “prompt sentence” refers to a text string that includes at least an explanation of summary information and a description of output conditions and that is provided as input to a generative AI model to obtain a desired type of output.
The term “generative AI model” refers to a trained information processing model that receives at least a prompt sentence and associated data as input and generates new text, rules, or other structures as output based on learned patterns.
The term “improvement proposal” refers to information generated by a generative AI model that specifies at least one candidate modification or extension of a fraud detection logic, a threshold, a pattern, or a warning message content.
The term “behavioral information” refers to information indicating at least one action performed by a user in response to a warning, including whether the user has terminated or continued a voice communication and optionally a time taken to perform the action.
The term “terminal device” refers to an information processing apparatus operated by a user, such as a portable communication terminal or a computing device, that executes at least a voice data processing function, a text data processing function, an emotion analysis function, and an integrated determination function.
The term “communication network” refers to a wired or wireless data transfer infrastructure through which a server and one or more terminal devices exchange digital information including pattern information, parameter information, and anonymized metadata.

In one embodiment, terminal, server, and user cooperate to implement a phishing-prevention system that operates across distributed hardware resources and improves the technical behavior of communication processing and machine-learning pipelines.

Terminal comprises a computing unit such as a processor, a memory, a nonvolatile storage device, a microphone, a speaker, a display, and a communication interface. Terminal executes an operating system, such as a mobile operating system, and runs an application program that implements at least a voice data processing function, a text data processing function, an emotion analysis function, an integrated determination function, and a warning notification function. Server comprises a computing unit such as a multi-core processor, a main memory, a nonvolatile storage device, and a network interface. Server executes a server operating system and runs at least a pattern storage function, an analysis data management function, an analysis enhancement function, an update processing function, and an update distribution function. User operates terminal to conduct ordinary voice communications and reacts to warnings presented by terminal.

Terminal uses its microphone and audio input interface to acquire communication voice data during a voice communication. Terminal applies an audio processing library, for example an implementation of a digital signal processing toolkit such as a WebRTC-based audio processing module or an FFmpeg-based filter chain, to perform noise reduction, echo cancellation, and sampling-rate conversion. Terminal converts stereo or multi-channel audio into a monaural stream at a predetermined sampling rate (for example, 16 kHz), and stores audio frames in a ring buffer in main memory. By performing these concrete signal-processing operations locally, terminal reduces the amount of data that must be processed by subsequent speech recognition and emotion analysis modules, thereby improving processing speed and reducing power consumption.

Terminal then executes a speech recognition engine as part of the voice data processing function. Terminal uses, for example, a compact deep neural network-based acoustic model and a decoding graph stored in its nonvolatile storage. In one implementation, terminal extracts Mel-frequency cepstral coefficients and other spectral features from buffered audio frames, normalizes the features, and passes them to a deep neural network such as a time-delay neural network or a recurrent neural network trained for acoustic modeling.

Terminal combines the neural network outputs with a language model and a lexicon to perform beam search decoding, thereby generating text information that represents recognized utterances. Terminal stores recognized text with timestamps in a data structure such as a time-ordered list or an array of records containing at least a speaker label, a start time, an end time, and a character string. This concrete data structure enables downstream components to align text segments with risk scores and emotional states at a fine temporal resolution.

Terminal executes the text data processing function by applying a natural language processing model and a classification model to the text information. Terminal uses a tokenizer, such as a subword tokenizer (for example, a WordPiece or SentencePiece tokenizer), to convert text into token identifiers. Terminal then applies a neural network-based model, for example a transformer-based language model with multiple attention layers and feed-forward blocks, which has been fine-tuned to classify input sequences into at least phishing-related and non-phishing-related categories. Terminal obtains an embedding representation for each token and computes a sequence representation, such as a pooled hidden state. Terminal inputs this representation into a classification layer, for example a fully connected layer followed by a softmax function, to obtain score information that indicates a fraud risk. In addition, terminal applies rule-based keyword matching using pattern information including keyword information and scenario information stored locally. Terminal adjusts the score information by adding or subtracting values based on detected keyword patterns and their positions. This combination of neural classification and structured rule-based adjustment improves detection accuracy compared to using only one of the methods and enables terminal to modulate risk evaluation based on patterns that are difficult to learn purely from data.

Terminal executes the emotion analysis function by processing both audio and text signals. Terminal uses the previously described audio processing pipeline to extract acoustic feature vectors, including at least pitch, energy, formant information, speaking rate, and silence durations. Terminal applies an emotion estimation model, which may be a neural network comprising convolutional layers and recurrent layers that are trained on labeled emotional speech. Terminal outputs probabilities for multiple emotion categories and estimates an intensity value for each category using, for example, a sigmoid output layer. In parallel, terminal applies a text-based emotion classifier to user utterance text. This model may share a common transformer encoder architecture with the phishing-classification model but be fine-tuned separately on emotion-labeled text data. Terminal combines audio-based and text-based emotion estimates by computing a weighted sum or by using a smaller fusion network, such as a multilayer perceptron with concatenated feature vectors as input. Terminal outputs an emotional state, represented as a combination of a dominant emotion category and a continuous intensity value. The use of multiple neural subsystems and feature fusion enables terminal to capture subtle patterns of stress and anxiety that are not apparent from text alone or audio alone, thereby improving the robustness of emotion detection purely at the device level.

Terminal executes the integrated determination function by receiving, as inputs, time-aligned score information from the text data processing function and emotional state information from the emotion analysis function. Terminal maintains a state structure that stores the latest score information, emotional state, and past values within a sliding time window. Terminal applies a decision algorithm that may be implemented as a rule engine or a small trained classifier, such as a gradient-boosting decision tree model. For example, terminal evaluates conditions of the form: if the score information exceeds a first threshold and the emotional state intensity for anxiety or panic exceeds a second threshold for longer than a specified period, then the risk level is set to a high stage. Terminal calculates risk level as a discrete value (low, intermediate, high) and stores it together with timestamps. By basing the risk level on a combination of content-based score information and user state, terminal reduces false alarms that would be generated by naive keyword detectors and reduces missed detections that would occur when content appears mildly suspicious but user distress signals are strong. This integration constitutes a specific improvement in the way the computer system aggregates heterogeneous signals to drive downstream control logic.

Terminal executes the warning notification function by selecting a warning message template from a set of stored templates. Terminal uses the risk level and the emotional state as input parameters and selects, for example, a more urgent but still calming message when the risk level is high and the user is anxious. Terminal composes a concrete message by filling placeholders with context parameters such as a generic name of the service category.

Terminal then controls the display hardware by invoking graphical interface modules of the operating system to draw a dialog or full-screen overlay, and controls the speaker by invoking a text-to-speech module to generate synthesized warning audio. Terminal also controls the telephony or communication subsystem by issuing commands through system APIs to terminate the call when user presses a displayed button. In this way, terminal does not merely display data; instead, terminal performs direct control over specific machine resources (audio hardware, display hardware, and communication interfaces) in accordance with the outputs of the integrated determination function. This tight coupling between machine-learning outputs and device-control operations constitutes a technical implementation that modifies the actual behavior of the communication device.

Server executes the pattern storage function by storing, in a storage device such as a relational database or a key-value store, pattern information, keyword information, scenario information, and parameter information of the models used by terminal. Server manages versioned configurations, where each version includes model weights for neural networks (for example, matrices of floating-point parameters for transformer layers), threshold values, and structured detection rules. Server exposes an application programming interface over a communication network so that terminal can request and download updated versions. This centralized pattern management enables consistent behavior across multiple terminals and allows coordinated updates without manual reconfiguration.

Server executes the analysis data management function by receiving anonymized metadata from multiple terminals. Anonymized metadata may be structured as records that contain, for each communication session, lists of timestamps, associated score information values, risk levels, emotional states, and user behavior flags indicating whether the call was terminated or continued after a warning. Server aggregates these records using data processing tools to compute statistical summaries, such as the frequency of non-terminated high-risk calls or average reaction time to specific warning templates. Server then compresses these statistics into summary information that captures the most relevant patterns while reducing data volume and removing residual sensitive elements. This structured arrangement of anonymized data reduces network load and server storage requirements compared to transmitting and storing raw audio or full transcripts, while still preserving the features necessary for model improvement.

Server executes the analysis enhancement function by forming a prompt sentence based on the summary information. Server constructs a text string that includes descriptions of observed patterns and explicit instructions specifying the type and format of outputs that are desired. For example, server may form a prompt sentence such as: “The following dataset summarizes call content, time-series phishing-risk scores, users' emotional states, and final user actions. Based on these data, propose new phishing-detection rules that explicitly incorporate emotional states. Output several rules in the format ‘Condition’ and ‘Risk level decision’.”

Server may also form prompt sentences for warning messages, such as:
“There are multiple cases where users were ‘anxious’ and ‘panicked’ but did not end the call despite receiving the current warning message. Based on the summary data below, generate 10 Japanese warning messages that more effectively encourage users to end the call or contact an official support number, without causing excessive psychological burden. Each message must be polite, within 60 Japanese characters, and include a specific action instruction.”

Server inputs such a prompt sentence, together with relevant portions of summary information (for example, representative patterns described as plain text), into a generative AI model. The generative AI model may be implemented as a transformer-based neural network with multiple encoder-decoder layers, self-attention mechanisms, and learned token embeddings, trained on large amounts of textual data and optionally fine-tuned on security-related corpora.

Server sets model parameters such as maximum output length and sampling temperature, and computes an output sequence of tokens representing candidate detection rules or warning messages.

Server executes post-processing to parse the generated text into structured candidate rules and messages. For detection rules, server identifies patterns such as conditional phrases describing thresholds on risk scores, emotional state categories, and durations, and encodes them into a rule representation, for example a machine-readable data structure with fields for feature names, comparison operators, threshold values, and resulting risk levels. For warning messages, server splits the output into individual sentences and verifies that each message satisfies specified constraints such as length and politeness markers. Server evaluates candidate proposals against stored anonymized metadata using offline simulation: server applies proposed rules to historical metadata records and measures expected detection metrics. This concrete evaluation process allows server to quantify improvements in detection accuracy or reduction of false warnings.

Server executes the update processing function by selecting, based on the evaluation results, one or more candidate rules and messages that meet predefined performance criteria. Server updates the pattern information and parameter information in the storage device by inserting or modifying rule entries and adjusting threshold values, and, when necessary, by triggering fine-tuning of neural network weights using additional labeled data derived from anonymized metadata. For example, server may train a new transformer-based classifier by minimizing a cross-entropy loss between predicted risk labels and ground-truth labels derived from historical server decisions, updating model parameters via stochastic gradient descent or an adaptive optimizer. Server stores the resulting model parameters and version numbers in the storage device.

Server executes the update distribution function by packaging updated pattern information and parameter information into versioned bundles and distributing them, via a secure communication protocol, to terminals. Terminal receives the update bundle, verifies its authenticity, and replaces old models and pattern tables with updated versions. As a result, subsequent communications processed by terminal use improved detection and warning logic. The feedback loop formed by terminal-side detection and server-side generative AI-driven optimization thus continuously refines both rule-based and model-based components of the overall system.

This architecture improves computer technology in several ways. First, by offloading only compact anonymized metadata rather than raw communication content, the system reduces network bandwidth consumption and server-side computational load, thereby improving scalability. Second, by performing multimodal fusion of content-based scores and emotional states in terminal, the system improves the precision and recall of phishing detection compared to systems limited to static keyword or text analysis, without materially increasing computational complexity due to the use of optimized on-device models. Third, by using a generative AI model with carefully structured prompt sentences to propose modifications to detection rules and warning templates, and by automatically evaluating and incorporating those proposals, server automates aspects of model and rule maintenance that are difficult or impossible for human operators to perform at scale. This automation is not a mere replacement of human judgment with a computer but rather a technical enhancement, because it enables faster adaptation to new patterns, complex multi-feature conditions that humans would not typically design, and systematic exploitation of high-dimensional metadata. Moreover, the described system employs specific data structures, such as time-aligned sequences of risk scores and emotional states, structured rule representations, and versioned configuration bundles, together with concrete algorithms, including audio preprocessing, neural network inference, rule evaluation, and gradient-based learning. These technical elements, and their particular combination, provide measurable benefits such as reduced latency in warning delivery, increased detection accuracy, lower false alarm rate, and improved management of model versions across a distributed population of devices. The causality between the claimed features and the technical effects is clear: improved feature extraction and fusion at terminal yields better real-time risk estimation; structured anonymized metadata and generative AI-based rule synthesis at server yields better rules and thresholds; and efficient distribution of updates ensures that each terminal's detection pipeline evolves along with changing external conditions. In this manner, server and terminal cooperate to provide a computer-implemented solution that goes beyond abstract data processing and materially improves the functioning of communication devices and networked computing systems.

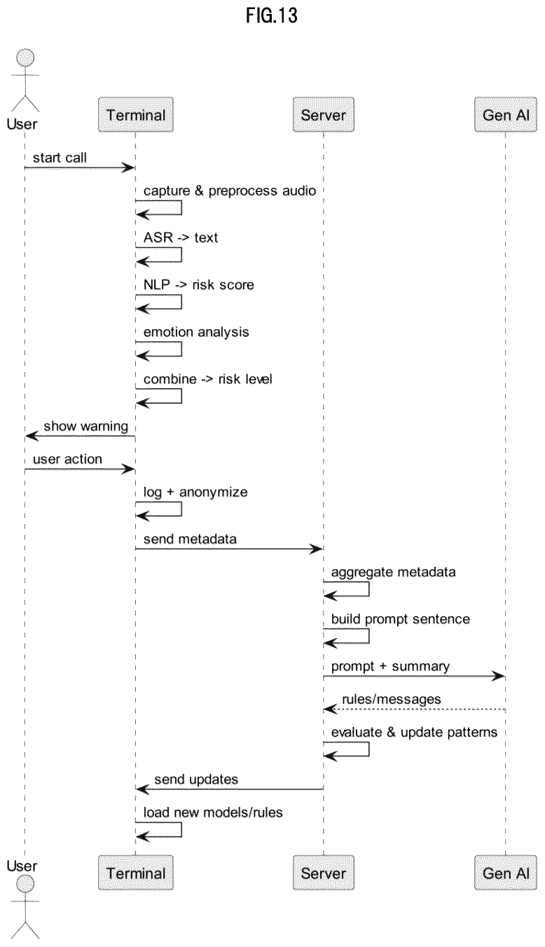

The following describes the processing flow using FIG. 13.

### Step 1:

Terminal receives, as input, a call start event from a communication application through an operating system interface.

Terminal, based on this input, initializes internal state for a new communication session, allocates memory buffers for audio data, risk scores, and emotional states, and starts acquiring communication voice data from a microphone and a call audio stream via an audio input interface.

Terminal outputs a continuous stream of raw audio frames, each frame including at least a sequence of sampled amplitude values and a timestamp, to an audio preprocessing pipeline. Step 2:

Terminal receives, as input, the raw audio frames from Step 1.

Terminal applies an audio processing library to perform data transformations including resampling to a target sampling frequency, channel mixing to mono, noise reduction through spectral subtraction or adaptive filtering, and echo cancellation by subtracting estimated echo components.

Terminal outputs preprocessed audio frames, each represented as a sequence of normalized samples at a fixed sampling rate and associated timestamps, to a speech recognition module and an audio-based emotion analysis module.

### Step 3:

Terminal receives, as input, the preprocessed audio frames for at least a user channel and optionally a counterparty channel.

Terminal segments the audio stream into utterance segments by computing short-time energy and detecting silence regions longer than a predefined duration. For each segment, terminal extracts acoustic features such as Mel-frequency cepstral coefficients and passes them to a neural-network-based acoustic model.

Terminal applies a decoding algorithm combining acoustic probabilities and a language model to obtain the most likely sequence of characters or words for each segment.

Terminal outputs text information as a sequence of records, each record including at least a speaker label, start time, end time, and a character string, to a text data processing function and a text-based emotion analysis function.

### Step 4:

Terminal receives, as input, the text records corresponding to counterparty utterances from Step 3.

Terminal applies a tokenizer to each character string to convert it into a sequence of token identifiers, and then feeds these token sequences into a natural language processing model configured as a transformer-based classifier. The model computes contextual embeddings and applies a classification layer to generate a base fraud-risk probability.

Terminal additionally loads keyword information and scenario information from local storage and performs pattern matching on the text to detect occurrences of predefined phishing-related terms or phrases. Terminal adjusts the base probability by increasing or decreasing the score according to matched patterns and their positions.

Terminal outputs score information, represented as a numerical value indicating a fraud risk for each text segment and including associated timestamps, to an integrated determination function and to a logging structure.

### Step 5:

Terminal receives, as input, user-side preprocessed audio frames from Step 2 and user utterance text records from Step 3.

Terminal extracts acoustic feature vectors such as pitch contours, energy envelopes, spectral centroid, and speech rate from the user-side audio, and feeds these features into an emotion estimation model comprising, for example, convolutional layers followed by recurrent layers. The model outputs probabilities for multiple emotion categories and intensity values.

Terminal also tokenizes the user utterance text and applies a text-based emotion classifier, generating category probabilities and intensities based on linguistic content. Terminal combines audio-based and text-based outputs by computing a weighted average or by passing concatenated feature vectors through a small fusion network to obtain a single emotional state and intensity.

Terminal outputs emotional state information, including an emotion label, an intensity value, and timestamps, to the integrated determination function and to a logging structure. Step 6:

Terminal receives, as input, the latest score information from Step 4 and the latest emotional state information from Step 5.

Terminal maintains a sliding time window over recent data and evaluates a set of decision rules or a trained decision model that takes as features the current and recent risk scores, emotion categories, emotion intensities, and durations above certain thresholds. Terminal computes a risk level by mapping these features to discrete levels such as low, intermediate, and high.

Terminal outputs risk level information, including the determined risk level and a timestamp, to a warning notification function and to an internal log buffer.

### Step 7:

Terminal receives, as input, the risk level information from Step 6 and the emotional state information from Step 5.

Terminal selects a warning message template from a repository of templates stored in local storage by evaluating selection conditions that reference the risk level and the emotional category. Terminal fills placeholder fields within the template using contextual parameters such as a generic service category and constructs a complete warning message string.

Terminal controls a display device by issuing drawing commands through a graphical user interface framework to render the warning message and interactive elements such as buttons for ending the call or ignoring the warning. Terminal also controls a text-to-speech engine by providing the message string as input and receiving synthesized audio frames as output, which terminal sends to an audio output device.

Terminal outputs user interaction events, including button selections and timestamps, to a behavioral log, and, when an “end call” input is detected, terminal outputs a control command to a communication interface to terminate the voice communication.

### Step 8:

Terminal receives, as input, the accumulated score information, emotional state information, risk level information, warning messages presented, and user interaction events logged during the communication session.

Terminal constructs anonymized metadata by combining these elements into a structured record that includes time-series arrays for scores and emotional states, a sequence of risk levels, identifiers for warning templates shown, and user behavior flags, while removing or masking personally identifiable information. Terminal applies hashing, truncation, and pattern-based redaction algorithms to text and identifiers to ensure anonymization. Terminal outputs anonymized metadata, represented for example as a structured data object containing numerical arrays and label fields, to a communication module for transmission to server, provided that user has permitted such transmission.

### Step 9:

Server receives, as input, anonymized metadata from multiple terminals through a communication network.

Server stores each metadata record in a storage device, indexing records by anonymized session identifiers and timestamps. Server then applies statistical analysis procedures that aggregate time-series risk scores, emotional states, risk levels, and outcomes across sessions. Server computes metrics such as the proportion of high-risk sessions with continued calls and the distribution of emotion intensities during warnings.

Server outputs summary information, including aggregated statistics, representative patterns, and textual descriptions of common scenarios derived from the anonymized metadata, to an analysis enhancement function.

### Step 10:

Server receives, as input, the summary information from Step 9.

Server generates a prompt sentence by composing a text description of the summary information and appending explicit instructions that define desired output types and constraints. Server may incorporate enumerated examples of patterns and specify that the output should consist of structured detection rules or concise warning messages. Server feeds the prompt sentence, and optionally embedded excerpts of summary information, into a generative AI model that processes the input sequence with an encoder-decoder transformer architecture. The generative AI model outputs a sequence of tokens that represent candidate detection rules or candidate warning messages.

Server outputs the raw generated text, segmented into individual proposals, to an evaluation and selection component.

### Step 11:

Server receives, as input, the candidate detection rules and candidate warning messages from Step 10, and optionally the anonymized metadata from Step 9.

Server parses each candidate detection rule into a structured representation by identifying conditions on features such as risk score thresholds, emotion categories, intensities, and durations, and associates each condition with a specified risk level decision. Server evaluates candidate rules by simulating their application on stored anonymized metadata and computing detection metrics such as true positive rate and false positive rate. For candidate warning messages, server checks length, politeness indicators, and presence of action instructions.

Server selects, based on evaluation results and predefined criteria, a subset of candidate rules and messages as improvement proposals and outputs these improvement proposals to an update processing function.

### Step 12:

Server receives, as input, the improvement proposals from Step 11 and the current pattern information and parameter information from a storage device.

Server updates pattern information by inserting or revising entries that specify keyword patterns, scenario patterns, and rule conditions as indicated by the selected detection rules.

Server also, when needed, adjusts parameter information such as decision thresholds used at terminal and may initiate additional model training using anonymized metadata to update neural network parameters. The training process uses an error function, such as cross-entropy loss, and iteratively updates model weights using gradient-based optimization until convergence criteria are met.

Server outputs updated pattern information and updated parameter information, encoded as versioned configuration bundles, to an update distribution function.

### Step 13:

Server receives, as input, the updated configuration bundles from Step 12 and version information requests from terminals over the communication network.

Server compares version identifiers contained in the terminal requests with the latest version identifiers stored in the storage device and determines whether an update is required. When an update is required, server packages the relevant updated pattern information and parameter information into a response payload and transmits the payload to the requesting terminals using a secure communication protocol.

Server outputs confirmation records for each distribution event to an internal log for monitoring, and terminals receiving the updates then replace their local pattern tables and models with the new versions, thereby closing the feedback loop and enabling improved on-device processing in subsequent communications.

### Step 14:

User receives, as input, the warning messages and interface elements displayed and sounded by terminal in Step 7 during a voice communication.

User interprets the warning content and selects an action, such as ending the call or ignoring the warning, by operating an input interface on terminal. This operation generates an interaction event that terminal records and uses in later anonymized metadata.

User, by following context-appropriate warnings that are continuously refined through server-side analysis and generative AI-based rule generation, experiences improved protection against fraudulent communications while terminal and server collaboratively adapt processing behavior to evolving patterns.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional threat and fraud detection technologies that operate on audio and text data typically rely on static keyword lists, fixed rule sets, or single-modal statistical classifiers. Such technologies often treat speech purely as text or purely as acoustic energy and therefore ignore nuanced contextual signals, such as the semantic content of the conversation combined with the speaker's emotional state over time and environmental attributes. As a result, existing systems tend to generate a high rate of false positives in benign but energetic situations (for example, cheering or joking) and a high rate of false negatives in calm but truly malicious scenarios (for example, sophisticated fraud spoken in a neutral tone). These limitations manifest as poor calibration of threat scores, unstable alert behavior, and an overall degradation of usable performance in real deployments.

Moreover, in typical architectures, once a detection model or rule set has been deployed, its internal logic is difficult to adapt in a principled way based on operational history. Engineers must manually inspect logs, re-label data, hand-tune thresholds, and redesign feature sets. This manual loop is slow, error-prone, and does not scale well as environments, attack patterns, and communication styles evolve. In particular, there is no systematic mechanism for a computer system itself to analyze structured detection history, formulate high-level descriptions of error patterns, and derive new algorithmic structures or parameterizations to reduce such errors.

In the area of privacy-sensitive communication, such as voice calls and electronic messages on user devices, conventional solutions frequently centralize data processing on remote computing platforms. This architecture exposes raw or lightly processed user data beyond the user's own device, increasing the risk of privacy breaches and regulatory non-compliance.

While some local-only solutions exist, they usually implement simplified detection logic without multimodal fusion or continuous algorithm improvement, which limits their effectiveness against sophisticated phishing and fraud attacks.

Accordingly, there is a need for a computer-implemented technique that improves core computing functions for threat and fraud detection. Such a technique should: (i) perform multimodal fusion of content-based and emotion-based indicators derived from acoustic signals and text, (ii) compute an integrated threat degree and determine a threat level with higher robustness to environmental variation, (iii) automatically leverage accumulated history data to generate structured learning data and prompt sentences for a generative AI model, (iv) obtain and apply algorithm improvement proposals from the generative AI model to update detection logic and model parameters, and (v) in privacy-sensitive use cases, execute at least part of the processing locally on user devices without transmitting personal data externally. By restructuring the way processors orchestrate data acquisition, feature computation, model inference, history management, and algorithm evolution, the invention aims to improve the technical performance, adaptability, and privacy characteristics of computer-implemented threat and fraud detection systems.

The specific processing by the specific processing unit 290 of the data processing device 12 in Application Example 2 is realized by the following means.

The present invention provides a server comprising at least one processor and at least one memory storing instructions that, when executed by the at least one processor, cause the at least one processor to acquire an acoustic signal from a monitored area, generate acoustic feature data based on the acoustic signal, perform speech recognition processing on at least one of the acoustic signal and the acoustic feature data to generate character string data, perform natural language processing on the character string data to detect threat-related or illicit-activity-related expressions and compute a content-based threat degree, estimate an emotional state of a speaker based on the acoustic feature data and the character string data and compute an emotion-based indicator including at least one of a panic degree and a stress degree, integrate the content-based threat degree and the emotion-based indicator to compute an integrated threat degree and determine a threat level or an illicit-activity level according to the integrated threat degree, generate warning information and transmit the warning information to a user information processing apparatus when the threat level or the illicit-activity level is equal to or greater than a predetermined level, store, as history data, at least the acoustic signal, the character string data, the content-based threat degree, the emotion-based indicator, the integrated threat degree, the warning information, and an evaluation result related to at least one of these, generate learning data based on the history data, generate a prompt sentence including statistical information based on the learning data and contents of at least one of a false detection case and a missed detection case, input the prompt sentence to a generative AI model as a generative information processing model, obtain an algorithm improvement proposal related to a threat detection algorithm from the generative AI model, and update at least one of a processing procedure and a parameter of at least one of a text data processing function, an emotion estimation function, and a threat determination function based on the algorithm improvement proposal. This enables the computing system to natively fuse multimodal content and emotion information, to compute and calibrate an integrated threat degree with improved accuracy, to continuously refine internal detection logic and model parameters using automatically generated prompt sentences and responses from a generative AI model driven by structured history data, and, when desired, to offload or mirror at least part of these enhanced detection functions onto user devices for local execution so as to reduce communication overhead and protect user privacy while improving the technical performance and adaptability of computer-implemented threat and fraud detection.
The term “acoustic signal” refers to a time-varying signal representing sound acquired from a physical or virtual space, including at least one of an analog waveform and a digitally sampled waveform.
The term “monitored area” refers to a physical or virtual region in which the presence or absence of a threat or illicit activity is to be monitored using at least one sensing device.
The term “acoustic feature data” refers to numerical feature values computed from an acoustic signal, including at least one of spectral coefficients, cepstral coefficients, energy values, pitch values, and time-frequency representations, and being usable as input to a machine learning model or signal processing algorithm.
The term “speech recognition processing” refers to processing that converts an acoustic signal or acoustic feature data into a symbolic representation of spoken content, including at least one of phoneme sequences, subword units, and word sequences.
The term “character string data” refers to a sequence of symbols representing linguistic content derived from speech recognition processing, including at least one of words, phrases, and sentences in a natural language.
The term “natural language processing” refers to processing that analyzes character string data in a human language, including at least one of tokenization, morphological analysis, syntactic analysis, semantic analysis, classification, and extraction of expressions related to a threat or illicit activity.
The term “threat-related expression” refers to a word, phrase, or combination of words in character string data that is predefined or inferred as being associated with a potentially harmful act, incident, or condition.
The term “illicit-activity-related expression” refers to a word, phrase, or combination of words in character string data that is predefined or inferred as being associated with a fraudulent, unauthorized, or otherwise unlawful act.
The term “content-based threat degree” refers to a numerical or categorical indicator that represents a likelihood or severity of a threat or illicit activity based on at least one of linguistic content, context, and statistical patterns extracted from character string data.
The term “emotional state” refers to a psychological condition of a speaker, such as anger, fear, anxiety, sadness, joy, or calmness, estimated from at least one of acoustic feature data and character string data.
The term “emotion-based indicator” refers to a numerical or categorical indicator computed from an estimated emotional state, including at least one of panic degree, stress degree, tension degree, and per-emotion probability values.
The term “panic degree” refers to a numerical indicator representing an estimated level of panic or extreme agitation of a speaker based on at least one of acoustic feature data, character string data, and temporal change of emotion-related values.
The term “stress degree” refers to a numerical indicator representing an estimated level of stress or pressure experienced by a speaker based on at least one of acoustic feature data, character string data, and temporal change of emotion-related values.
The term “integrated threat degree” refers to a numerical or categorical indicator that represents a comprehensive threat level computed by integrating at least the content-based threat degree and the emotion-based indicator.
The term “threat level” refers to a classification category, derived from the integrated threat degree, indicating at least one of presence, absence, and severity of a threat.
The term “illicit-activity level” refers to a classification category, derived from the integrated threat degree, indicating at least one of presence, absence, and severity of an illicit or fraudulent activity.
The term “warning information” refers to information generated in response to a threat level or an illicit-activity level satisfying a predetermined condition, the information including at least one of a message, a location, a timestamp, and a classification of the threat or illicit activity.
The term “user information processing apparatus” refers to an information processing device operated or possessed by a user, including at least one of a mobile terminal, a stationary terminal, and a control apparatus with a display unit.
The term “history data” refers to stored data including at least one of an acoustic signal, character string data, a content-based threat degree, an emotion-based indicator, an integrated threat degree, warning information, and an evaluation result related to at least one of these.
The term “learning data” refers to structured data generated from history data and configured for use in at least one of training, fine-tuning, validating, and updating a model or algorithm used for threat or fraud detection.
The term “prompt sentence” refers to a text sequence provided as input to a generative AI model, the text sequence including at least one of statistical information derived from learning data, a description of a false detection case, and a description of a missed detection case, and being configured to elicit an algorithm improvement proposal.
The term “generative AI model” refers to a generative information processing model, implemented by a machine learning system, that receives a prompt sentence and outputs generated information including at least one of algorithm structures, rule proposals, parameter suggestions, and pseudocode.
The term “algorithm improvement proposal” refers to information output from a generative AI model in response to a prompt sentence, the information including at least one of a modification of a feature set, a change of a threshold, a change of a model structure, and a change of a combination rule for scores used in threat detection.
The term “text data processing function” refers to a processing function executed by at least one processor that performs natural language processing on character string data and computes at least a content-based threat degree.
The term “emotion estimation function” refers to a processing function executed by at least one processor that estimates an emotional state of a speaker based on at least one of acoustic feature data and character string data and computes at least one emotion-based indicator.
The term “threat determination function” refers to a processing function executed by at least one processor that integrates at least a content-based threat degree and an emotion-based indicator to compute an integrated threat degree and determine at least one of a threat level and an illicit-activity level.
The term “warning notification function” refers to a processing function executed by at least one processor that generates and outputs warning information to a user information processing apparatus based on at least one of an integrated threat degree, a threat level, and an illicit-activity level.
The term “processing procedure” refers to an ordered set of operations executed by at least one processor to implement a function, including at least one of selection of input data, ordering of processing steps, and logical conditions applied during processing.
The term “parameter” refers to a numerical value, threshold, weight, coefficient, or configuration value used in at least one of a model, a rule, and a processing procedure for threat or fraud detection.
The term “distributed information processing apparatus” refers to an information processing system including multiple computing resources that cooperate via a communication network to execute at least part of audio processing, text processing, emotion estimation, threat determination, history management, and algorithm updating.
The term “terminal apparatus” refers to an endpoint device that acquires an acoustic signal, transmits data to a server, and receives and presents warning information, including at least one of a portable communication device and a stationary display device.
The term “fraudulent request” refers to a request made in communication content that is associated with at least one of phishing, impersonation, unauthorized acquisition of credentials, and unauthorized acquisition of financial information.
The term “phishing fraud” refers to an illicit activity in which an attacker attempts to deceive a user into disclosing confidential information or performing an unauthorized operation by using spoofed communication content such as voice calls or electronic messages.
The term “electronic communication data” refers to data representing electronic messages transmitted or received by a user information processing apparatus, including at least one of a subject, a body, a sender address, a destination address, a link destination, and attached data.
The term “reference resource” refers to an external resource designated by electronic communication data, including at least one of a network address, a hyperlink destination, and a storage location for attached data.
The term “attached data” refers to data that is appended to electronic communication data, including at least one of a file, an executable object, and an embedded resource.

In an embodiment, a server, a terminal, and a user cooperate to implement the invention.

The server uses a hardware configuration including at least one general-purpose processor, at least one parallel computation processor, a main memory, a nonvolatile storage device, and a network interface. The server runs a general-purpose operating system, a web server program, an application server framework, at least one machine learning framework, at least one audio processing library, and at least one database management system. The server stores executable instructions in the nonvolatile storage device, and the processor loads the instructions into the main memory to realize the functions described below.

The terminal uses a hardware configuration including at least one processor, a memory, a microphone, a speaker, a display unit, an input unit, a vibration actuator, and a wireless or wired communication module. The terminal runs a client operating system and a client application program that interacts with the server, acquires acoustic signals from a monitored area, and presents warning information to the user.

The user is present in the monitored area and performs normal speech acts, such as conversation, calls, or shouts, without being required to operate a special interface. The user holds or is located near at least one terminal that collects acoustic signals.

The server configures modules in the application program to correspond to functional units described in the claims: an audio data processing function, a text data processing function, an emotion estimation function, a threat determination function, a warning notification function, a history data management function, an algorithm improvement proposal acquisition function, and an algorithm update function. The server defines data structures in the storage device to store acoustic signals, acoustic feature data, text strings, emotion indicators, threat scores, warning records, and learning datasets.

The server uses an audio processing library, such as a multimedia processing library or an audio analysis library, to manipulate acoustic signals at the sample level. The server stores each acoustic signal in a digital format, such as pulse code modulation with a sampling frequency of 16 kHz and 16-bit resolution. The server divides each acoustic signal into frames and uses the audio processing library to compute time-frequency representations, such as short-time Fourier transforms and mel-filterbank outputs.

The server computes acoustic feature data as vectors. The server includes, in each feature vector, mel-frequency cepstral coefficients, log-mel filterbank energies, pitch-related features, frame energy, spectral centroid, spectral flatness, and zero-crossing rate. The server arranges these feature vectors into a two-dimensional matrix where one dimension corresponds to time frames and the other dimension corresponds to feature dimensions. The server stores a reference to this matrix in association with an audio identifier, a terminal identifier, and metadata such as location and time.

The server uses a speech recognition model implemented in a machine learning framework such as a numerical computation library or a neural network library. The server implements, in one embodiment, an encoder-decoder neural network with an attention mechanism or a connectionist temporal classification model. The server defines a network architecture including at least one feature encoder portion (e.g., a stack of convolutional layers followed by recurrent or self-attention layers), at least one sequence modeling portion (e.g., a recurrent neural network or transformer layers), and at least one output projection portion that maps hidden states to subword or character distributions.

The server defines a loss function for speech recognition, such as a connectionist temporal classification loss or a cross-entropy loss on aligned sequence outputs, and uses an optimization algorithm such as stochastic gradient descent with momentum or adaptive moment estimation to update network weights during training. The server trains the speech recognition model in an offline phase using labeled pairs of acoustic feature sequences and ground-truth text transcripts stored in the storage device. The server stores the resulting trained model parameters in the storage device and loads them into memory for inference.

The server, during operation, applies the trained speech recognition model to acoustic feature data. The server feeds the matrix of acoustic feature vectors into the encoder portion, obtains a sequence of hidden representations, and uses a decoding algorithm such as beam search to find the most likely sequence of language tokens. The server concatenates these tokens into a character string in a natural language, such as a sentence, and computes confidence scores based on the probability distribution over alternative sequences. The server stores the character string and confidence score in the database, linked to the audio identifier and metadata.

The server uses a text data processing function implemented using a natural language processing library and a pre-trained language model. The server first tokenizes the character string into basic units (e.g., subword tokens) and applies morphological analysis and syntactic parsing to identify grammatical roles and dependencies. The server then feeds the token sequence into a contextual representation model, such as a transformer-based encoder, that has been pre-trained on large-scale text data. The server obtains an embedding vector for each token and an aggregate embedding for the entire utterance.

The server implements, as part of the text data processing function, a classifier model that receives the utterance-level embedding and outputs probabilities of belonging to threat-related or illicit-activity-related categories, such as fire, intrusion, violence, or fraud. The server defines the classifier as a multilayer perceptron with at least one hidden layer and a non-linear activation function, and it trains the classifier using supervised learning on labeled training data that associates utterances with threat categories. The server also implements an anomaly detection model, such as an autoencoder or an isolation forest, that receives the same or similar embeddings and outputs an anomaly score indicating deviation from normal conversation patterns.

The server computes a content-based threat degree by combining the category probabilities and the anomaly score. The server can implement this combination as a linear or non-linear function, such as a small neural network or a regression tree ensemble, that outputs a scalar score in a predefined range, for example 0 to 100. The server further adjusts the content-based threat degree by applying rule-based contributions when specific threat-related or illicit-activity-related expressions occur, such as words or phrases related to urgent help requests, financial transfers, or explicit references to suspicious behavior. The server stores the content-based threat degree as a field in the database.

The server uses an emotion estimation function to compute emotion-based indicators. The server implements an acoustic emotion recognition model that receives the acoustic feature data and outputs probabilities for emotion categories including anger, fear, anxiety, sadness, joy, and neutral. The server can define the acoustic emotion model as a convolutional and recurrent neural network or as a transformer encoder, with an output layer that maps hidden states to emotion probabilities. The server trains this model using labeled data comprising acoustic features and expert-labeled emotion categories, minimizing a cross-entropy loss between predicted and actual emotion labels.

The server also implements a text-based emotion analysis model that receives the character string or its embedding and outputs emotion probabilities and scalar scores such as negativity and anxiety level. The server may use a transformer-based language model fine-tuned on emotion-labeled corpora. The server combines the acoustic emotion probabilities and textual emotion scores into a concatenated feature vector. The server retrieves recent emotion outputs for the same area or terminal from the database and computes temporal features such as the rate of change of fear over a specified time window.

The server passes the concatenated multimodal and temporal features to an integration network that outputs emotion-based indicators, including at least a panic degree and a stress degree. The server defines this integration network as a multilayer perceptron with one or more hidden layers and uses a regression loss (e.g., mean squared error) during training against ground-truth annotations of panic and stress levels. The server stores the panic degree, stress degree, and related values in the database.

The server uses a threat determination function to compute an integrated threat degree. The server prepares a feature vector for each event, including the content-based threat degree, the probabilities for individual threat categories, the panic degree, the stress degree, other emotion probabilities, and environmental attributes such as the type of area and time-of-day coded as categorical or numeric features. The server feeds this vector into a model such as a gradient boosting decision tree ensemble or a neural network that has been trained to predict whether an event corresponds to no threat, low threat, medium threat, or high threat.

The server transforms the model output into an integrated threat degree in a continuous range, and applies threshold values stored in a configuration table to assign a threat level or illicit-activity level category. The server writes the integrated threat degree and level to the database. Because the model simultaneously uses linguistic content, multimodal emotion features, and environmental information, the server improves detection accuracy in conditions where conventional keyword-only or single-modal approaches fail. The server thus realizes a technical improvement in classification performance and stability for threat detection.

The server uses a warning notification function to generate and transmit warning information.

The server retrieves, from the database, the relevant character string, content-based threat degree, emotion-based indicators, integrated threat degree, threat level, area, and time. The server uses a template engine to fill a natural-language template with these values, generating a warning message. The server forms a structured warning record containing the message, the threat level, identifiers, and timestamps. The server transmits this warning record to one or more terminals through a push notification service or a persistent communication channel.

The terminal receives the warning record and uses the client application to present the warning. The terminal displays the message on the display unit with a visual style corresponding to the threat level, such as color coding or an enlarged area. The terminal optionally plays a sound through the speaker and activates the vibration actuator. The terminal enables the user to open a detailed view that shows the recognized utterance, estimated emotions, and the location on a map. In this way, the invention provides a concrete control of output devices (display, speaker, vibration) based on computed threat degrees, and does not remain a mere abstract evaluation of text.

The user, after inspecting the actual situation, can input feedback via the terminal. The user selects labels such as “real threat”, “false alarm”, or “no decision” and can optionally input a comment. The terminal packages this feedback with an event identifier and transmits it to the server. The server receives and stores the feedback as part of history data.

The server uses a history data management function to structure and maintain history data.

The server defines an event record schema that includes at least the acoustic signal identifier, the acoustic feature reference, the character string, the content-based threat degree, the emotion-based indicators, the integrated threat degree, the threat level, the warning information, feedback labels, comments, and environment attributes. The server periodically runs batch processes that aggregate such records into learning datasets.

The server groups history records according to feedback labels and system outputs, for example “false detection”, “missed detection”, and “correct detection”. The server extracts input features from each group, such as acoustic feature vectors, text embeddings, emotion scores, and environment attributes, and associates them with supervisory labels that reflect the desired system behavior. The server then stores these learning datasets in a persistent storage area for use in retraining or analysis.

The server uses an algorithm improvement proposal acquisition function based on a generative AI model. The server generates a prompt sentence that describes, in natural language, error patterns and available features. The server may generate a prompt sentence such as:
“The current threat detection system produces many false alarms in sports viewing areas of commercial facilities, where crowd cheering and loud shouts are misclassified as high anger or panic. The available input features include MFCCs, pitch, energy, text content, emotion scores (anger, fear, joy, etc.), area type (sports viewing area, dining area, office area, etc.), and time-of-day. Considering these features, propose feature engineering methods and a threat scoring logic that can distinguish sports-related cheering from truly violent angry shouting.”

The server may also generate a prompt sentence such as:
“Using time-series emotion scores (fear, panic level, anxiety level, etc.) computed from audio and text data, design an algorithm in pseudocode to detect crowd panic at an early stage. The input is the time evolution of fear scores for multiple speakers over the past 5 minutes.” The server may further generate a prompt sentence such as:
“Propose a time-dependent scoring logic that keeps the threat score low when the user's emotional state corresponds to jokes or excitement during sports viewing, while rapidly increasing the threat score when fear or panic grows continuously over time.”

The server constructs such prompt sentences by summarizing statistical information from the learning datasets, including false positive rates in specific area types, distributions of emotion scores, and empirical correlations between features and feedback labels. The server transmits the prompt sentence as input text to a generative AI model provided as a generative information processing model, which runs on the same server or on another computing system.

The server receives, from the generative AI model, a response that contains an algorithm improvement proposal. The response can include proposed new feature definitions (e.g., ratios between joy and anger scores), new rule conditions (e.g., ignoring high anger if joy is also high in specific environments), threshold selection strategies, and recommended model architectures (e.g., adding temporal smoothing layers). The server parses the response and extracts implementable elements.

The server uses an algorithm update function to integrate the algorithm improvement proposal into the threat detection system. The server represents rules and configuration parameters as machine-readable structures, such as configuration files or database tables. The server modifies these structures to include new rules that adjust the integrated threat degree based on area type and emotion combinations. The server updates feature extraction pipelines to compute new derived features specified in the algorithm improvement proposal.

The server retrains or fine-tunes the relevant models, such as the text classifier, the emotion integration network, or the threat integration model, using the updated learning datasets and newly introduced features. The server defines loss functions appropriate for each task, such as cross-entropy for classification and mean squared error for regression. The server uses optimization algorithms to update model weights, applies regularization techniques such as dropout or weight decay, and can perform early stopping based on validation metrics. The server evaluates revised models using held-out data and compares accuracy, false positive rate, and false negative rate with the previous versions.

The server, upon confirming improvement in metrics, deploys the updated models and configurations into the runtime environment by replacing stored parameter files and reloading them into memory. As a result, the server continuously refines its internal logic based on structured history data and generative model suggestions.

This embodiment improves computer technology by providing a feedback loop where the server not only performs classification but also reconfigures its own classification logic using past performance and automatically generated proposals. The server reduces communication load by enabling a portion of the processing to run locally on the terminal or user information processing apparatus, in some configurations, particularly for privacy-sensitive audio or message analysis. In such configurations, the terminal can run a reduced version of the audio data processing and text data processing functions, using on-device models, and send only aggregated threat indicators to the server.

Because the server integrates multimodal information at the feature level (acoustic, textual, emotional, and environmental), and because it uses a generative AI model to search a larger design space of feature combinations and thresholding strategies than would be feasible with manual tuning, the system achieves improved detection performance and computational efficiency. The server reduces unnecessary alerts in noisy environments such as sports venues by learning specific patterns of cheering and joy, and it improves detection of subtle fraud by paying attention to content context even when acoustic cues suggest calmness. The server thus achieves technical effects of higher detection accuracy, lower error rates, better calibration of scores, and, in some deployment options, reduced bandwidth consumption and improved privacy preservation.

In alternative embodiments, the server can implement different neural network architectures for speech recognition, emotion estimation, or threat integration, such as temporal convolutional networks or recurrent transformer variants. The server can use different feature sets, such as raw waveform inputs for end-to-end models, or include additional sensors from terminals, such as environmental noise level readings. The server can also distribute computation between multiple physical servers, or run lighter-weight models directly on the terminal, while still using the same principles of multimodal fusion, integrated threat scoring, history-driven learning data generation, prompt sentence creation, and generative AI-based algorithm refinement.

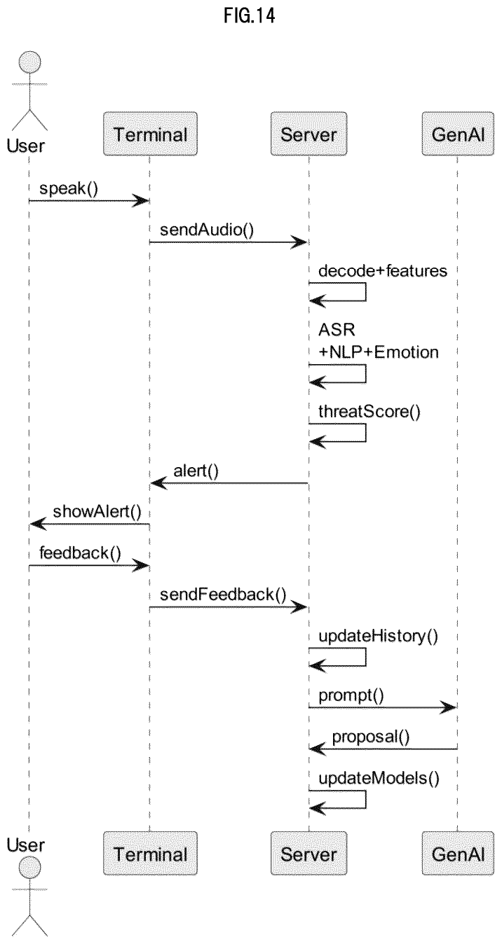

The following describes the processing flow using FIG. 14.

### Step 1:

The user generates speech in the monitored area.

The user provides, as input, real-world sound in the form of air vibrations produced by normal conversation, phone calls, or shouts, such as “Help me”, “There is smoke in the back room”, or “Where should I write my account number?”.

The user varies voice loudness, pitch, speaking rate, and tone depending on the situation, and these variations implicitly encode emotional state such as fear, anger, or excitement.

The user does not perform any explicit operation on the terminal; the output of this step is a sound field that can be captured by the microphone of the terminal.

### Step 2:

The terminal captures and digitizes the acoustic signal.

The terminal receives, as input, the air vibrations from the user's speech at the microphone.

The terminal uses an audio input API of the client operating system to sample the analog microphone signal at a predetermined sampling rate (for example, 16 kHz, 16-bit, mono) and converts the analog waveform into a sequence of digital samples (PCM data).

The terminal performs data processing by segmenting the PCM stream into short frames (e.g., 20-40 ms) and buffering these frames into larger chunks (e.g., 1 second) in memory. The terminal may apply simple preprocessing such as automatic gain control or basic noise reduction provided by an audio processing library to normalize the level and reduce background hum.

The terminal then encodes the buffered PCM data into a compressed audio format (for example, an adaptive audio codec) using a multimedia codec library, thereby transforming raw samples into a more compact binary bitstream.

The output of this step is a compressed audio payload and associated metadata including at least a terminal identifier, approximate position, and local timestamp.

### Step 3:

The terminal transmits the compressed audio and metadata to the server.

The terminal receives, as input, the compressed audio payload and metadata produced in Step 2.

The terminal constructs an HTTP or equivalent request message, puts the metadata into request headers or a structured body (for example, JSON fields), and attaches the compressed audio payload as binary data. The terminal uses a secure transport protocol (for example, HTTPS over TCP/IP) via its network interface to serialize and send these bytes over a communication network.

The terminal performs data processing by formatting the payload according to an application-level protocol (for example, a REST-style API), setting authentication tokens, and computing checksums as required.

The output of this step is a network message stream that reaches the server and a local log on the terminal indicating that the audio packet was sent and whether the server acknowledged the request.

### Step 4:

The server receives and decodes the compressed audio.

The server receives, as input, the network message containing the compressed audio payload and metadata.

The server uses a web server and application server to parse the incoming request, extract the terminal identifier, location, and timestamp from the headers or request body, and pass the compressed audio bytes to a decoding component.

The server calls functions of a multimedia processing library to convert the compressed bitstream back into linear PCM samples at a canonical sampling rate and sample width (for example, 16 kHz, 16-bit). The server thereby performs data processing that maps compressed frames into a continuous digital waveform.

The server stores the decoded PCM data in a buffer or temporary storage and associates it with a newly generated audio identifier and the received metadata.

The output of this step is an internal acoustic signal in PCM format and a structured record containing the audio identifier and its metadata.

### Step 5:

The server performs noise reduction and acoustic feature extraction.

The server receives, as input, the PCM acoustic signal and its metadata from Step 4.

The server applies a noise suppression algorithm using an audio processing library or a trained denoising model. The server typically divides the signal into overlapping frames, computes short-time spectra, estimates background noise, and subtracts or attenuates noise components to enhance speech components. This processing produces a denoised waveform.

The server then computes acoustic feature data by applying signal processing functions to the denoised frames. For each frame, the server calculates features such as mel-frequency cepstral coefficients, log-mel filterbank energies, frame energy, pitch, spectral centroid, spectral flatness, and zero-crossing rate. The server concatenates these numerical values into feature vectors and organizes them into a time-indexed feature matrix.

The server stores a reference to this feature matrix in association with the audio identifier. The output of this step is a denoised acoustic signal and an acoustic feature matrix suitable for input to speech recognition and emotion estimation models.

### Step 6:

The server executes speech recognition to generate character string data.

The server receives, as input, the acoustic feature matrix and optionally the denoised waveform from Step 5.

The server feeds the acoustic feature matrix into a speech recognition model implemented in a machine learning framework. The model may consist of an encoder that transforms frame-level features into hidden representations, followed by a sequence decoding mechanism such as connectionist temporal classification or an attention-based decoder.

The server performs data processing by computing, at each time step, probability distributions over subword units or characters, and then running a decoding algorithm such as beam search to identify the most probable sequence of tokens. The server concatenates these tokens into one or more sentences forming character string data.

The server simultaneously computes a confidence value based on the probabilities assigned to the chosen sequence relative to alternative hypotheses.

The output of this step is character string data that represents the recognized utterance and an associated recognition confidence score, which the server stores in a database together with the audio identifier and metadata.

### Step 7:

The server analyzes the text and computes a content-based threat degree.

The server receives, as input, the character string data and recognition confidence from Step 6.

The server tokenizes the text and applies natural language processing, including morphological analysis and syntactic parsing, to identify tokens, parts of speech, and dependency relations. The server then transforms the sequence of tokens into an embedding representation using a contextual language model.

The server performs data processing by passing the utterance-level embedding into a classifier network that outputs probabilities for different threat-related or illicit-activity-related categories (for example, fire, intrusion, violence, fraud). The server may also pass the embedding into an anomaly detection model that outputs a scalar anomaly score.

The server further scans the text for predefined patterns, such as certain phrases or combinations of words, and applies rule-based scoring increments when such expressions occur.

The server combines category probabilities, the anomaly score, and rule-based increments via a weighted formula or small integration model to compute a scalar content-based threat degree within a specified range, such as 0 to 100.

The output of this step is the content-based threat degree and auxiliary values (category probabilities and anomaly score) linked to the same audio identifier and stored in persistent storage.

### Step 8:

The server estimates the emotional state and computes emotion-based indicators.

The server receives, as input, the acoustic feature matrix from Step 5 and the character string data from Step 6.

The server passes the acoustic feature matrix into an acoustic emotion recognition model that outputs a probability vector over emotion categories such as anger, fear, anxiety, sadness, joy, and neutral. The server interprets this vector as an acoustic emotion index.

The server also passes the character string data or its embedding into a text-based emotion analysis model that outputs, for each emotion category, a probability or score and additional scalar measures such as negativity or anxiety level. The server interprets this as a linguistic emotion index.

The server retrieves previously stored emotion outputs for the same area or terminal over a recent time window and performs data processing to compute temporal features, such as the rate of increase of fear scores or variance of joy scores over time.

The server concatenates the acoustic emotion index, the linguistic emotion index, and the temporal features into a single feature vector, and feeds this vector into an integration network that outputs continuous emotion-based indicators, including at least a panic degree and a stress degree normalized between 0 and 1.

The output of this step is a set of emotion-based indicators (panic degree, stress degree, and related values) stored in association with the event record.

### Step 9:

The server computes an integrated threat degree and determines a threat level.

The server receives, as input, the content-based threat degree from Step 7, the emotion-based indicators from Step 8, and environment attributes obtained from a configuration store (for example, area type and time-of-day).

The server constructs a feature vector containing at least the content-based threat degree, threat category probabilities, panic degree, stress degree, other emotion probabilities, and environment attributes encoded as numeric vectors.

The server performs data processing by passing this feature vector into a threat integration model such as a gradient boosting decision tree ensemble or a neural network. The model outputs a scalar integrated threat degree that summarizes the overall risk.

The server compares the integrated threat degree with a set of threshold values stored in configuration. Based on these comparisons, the server assigns a discrete threat level or illicit-activity level, such as “no threat”, “low threat”, “medium threat”, or “high threat”.

The output of this step is the integrated threat degree and the assigned threat level, which the server stores as part of the event record.

### Step 10:

The server generates warning information and sends it to the terminal.

The server receives, as input, the integrated threat degree and threat level from Step 9, together with the character string data, emotion-based indicators, and metadata (such as area and timestamp).

The server verifies whether the threat level is equal to or higher than a predetermined notification threshold. If so, the server composes warning information. The server performs data processing by filling a message template with specific values: location, time, recognized text, threat category, and emotion summary (e.g., high fear and high panic).

The server constructs a structured warning record that includes the full message, threat level, identifiers, and optional links to supporting data (e.g., audio ID). The server then uses a notification mechanism, such as a push notification service or a message queue, to serialize and transmit this record to one or more terminals associated with relevant users. The output of this step is a warning record that travels over the network to a terminal and is logged in the server as a sent notification.

### Step 11:

The terminal receives the warning information and notifies the user.

The terminal receives, as input, the warning record transmitted by the server in Step 10. The terminal decodes the structured data, extracts fields such as threat level, message text, location, and timestamp, and maps the threat level to a notification style. The terminal performs data processing by preparing a user interface element—such as a notification banner or full-screen alert—with the decoded text and visual emphasis corresponding to the severity. The terminal then invokes operating-system-level APIs to display the alert on the display unit, to play a warning sound via the speaker, and to drive the vibration actuator if configured. These operations cause physical changes in the terminal hardware that alert the user. The output of this step is a visible and/or audible alert to the user and a local log entry indicating that the alert was displayed.

### Step 12:

The user reacts to the warning and optionally submits feedback.

The user receives, as input, the warning displayed or sounded by the terminal in Step 11. The user uses the displayed information (text description, location, level) to decide on an action, such as checking the scene, contacting colleagues, or reviewing related sensor data. After resolving the situation, the user may operate the terminal's user interface to open a feedback screen associated with the event.

The user selects at least one feedback category (for example, “real threat”, “false alarm”) and may type an explanatory comment. The terminal packages this feedback with the event identifier and sends it to the server as structured data over a secure connection. The output of this step is a feedback payload that encodes the user's evaluation of the system's decision and that becomes additional input for the server's history and learning processes.

### Step 13:

The server stores history data and constructs learning datasets.

The server receives, as input, the feedback payload from Step 12, together with the previously stored event record (acoustic signal reference, character string data, content-based threat degree, emotion-based indicators, integrated threat degree, threat level, and warning information).

The server updates the event record to include the feedback label and any comment text, and then classifies the event into categories such as false detection, missed detection, or correct detection using predefined rules comparing system outputs with feedback.

The server periodically performs data processing to aggregate many such records into learning datasets. The server extracts, for each record, input features (acoustic feature sequences, text embeddings, emotion scores, environment attributes) and target labels (intended threat outcome or error category). The server structures these into matrices and label vectors suitable for model training or analysis and stores them in a persistent training-data repository.

The output of this step is one or more structured learning datasets annotated with performance information.

### Step 14:

The server generates a prompt sentence and queries the generative AI model.

The server receives, as input, the learning datasets and aggregated statistics derived from them, such as false positive rates in specific area types or patterns of missed detections.

The server performs data processing by summarizing these statistics into natural-language descriptions, selecting representative error cases, and encoding available feature information (e.g., “MFCCs, pitch, energy, text content, emotion scores, area type, time-of-day”).

The server composes a prompt sentence that describes the technical problem and requests specific algorithmic improvements. For example, the server may generate:
“The current threat detection system produces many false alarms in sports viewing areas of commercial facilities, where crowd cheering and loud shouts are misclassified as high anger or panic. The available input features include MFCCs, pitch, energy, text content, emotion scores (anger, fear, joy, etc.), area type (sports viewing area, dining area, office area, etc.), and time-of-day. Considering these features, propose feature engineering methods and a threat scoring logic that can distinguish sports-related cheering from truly violent angry shouting.” The server then sends the prompt sentence as a textual request to a generative AI model endpoint using an API that accepts input text and returns generated text.

The output of this step is a generative AI model response containing at least one algorithm improvement proposal expressed in natural language.

### Step 15:

The server parses the algorithm improvement proposal and updates internal algorithms.

The server receives, as input, the generative AI model's response from Step 14.

The server analyzes the response text to identify concrete suggestions, such as new feature definitions (for example, a ratio of joy to anger scores over a time window), additional rule conditions (for example, reducing the effect of anger when joy is high in a sports area), or revised threshold values for the integrated threat degree.

The server performs data processing by mapping these suggestions into structured configuration changes or modifications of model input pipelines. The server updates configuration files or database tables to add or adjust rules, derives new feature computation formulas, and prepares updated training scripts or parameters.

The server then retrains or fine-tunes the relevant models (text classifier, emotion integration network, threat integration model) using the updated learning datasets and expanded feature sets. The server uses appropriate loss functions and optimization methods to compute new model weights and evaluates the new models against validation data. If evaluation metrics improve, the server deploys the updated models and configurations by replacing old parameter files and reinitializing the runtime components.

The output of this step is an updated set of detection algorithms and parameters that are automatically refined based on operational history and generative AI-derived proposals, which the server then uses in subsequent executions of Steps 5 through 9.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

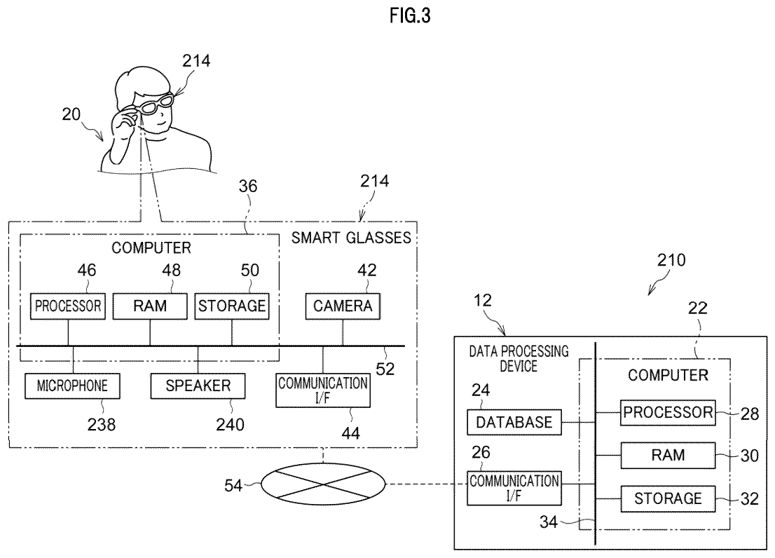

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

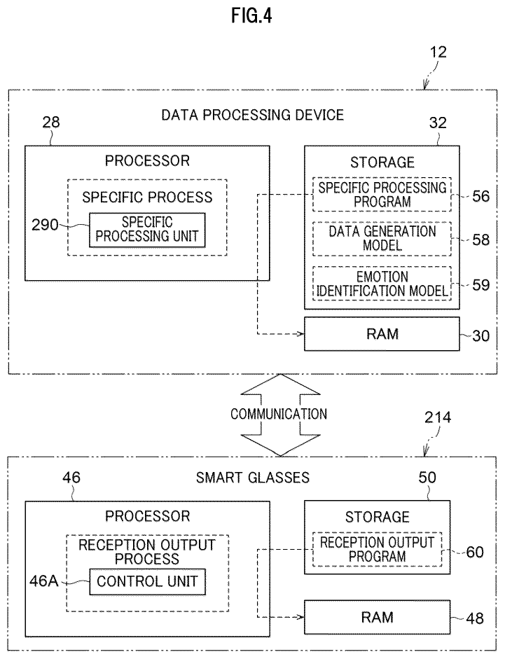

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

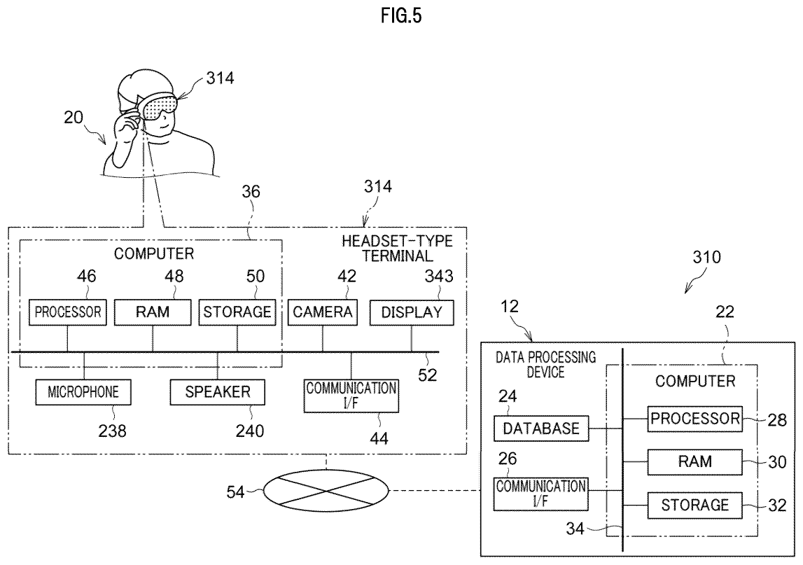

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

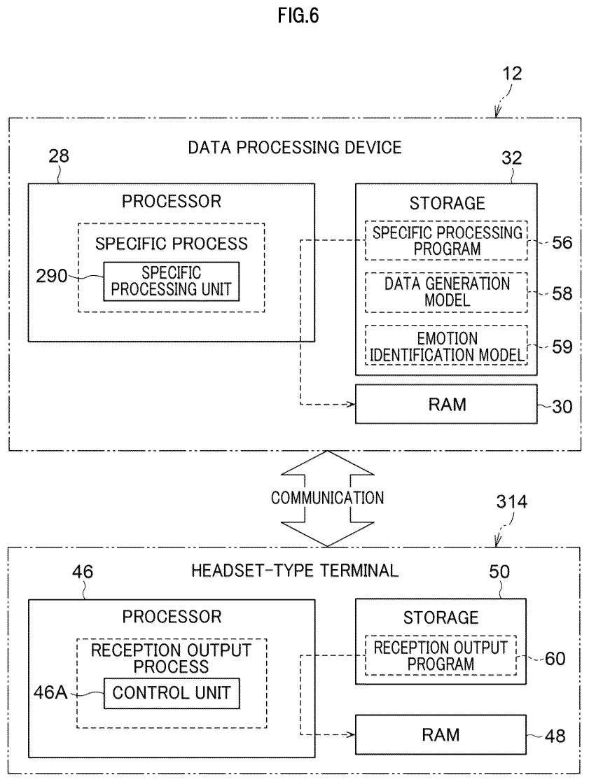

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

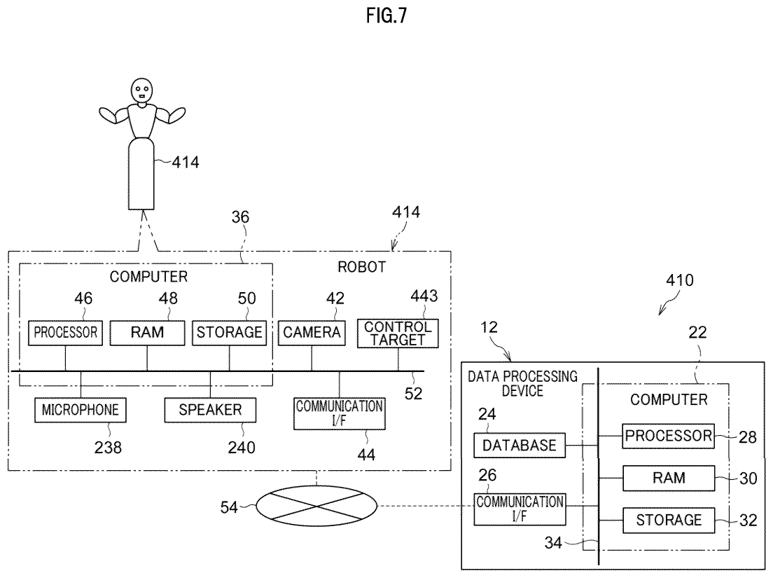

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

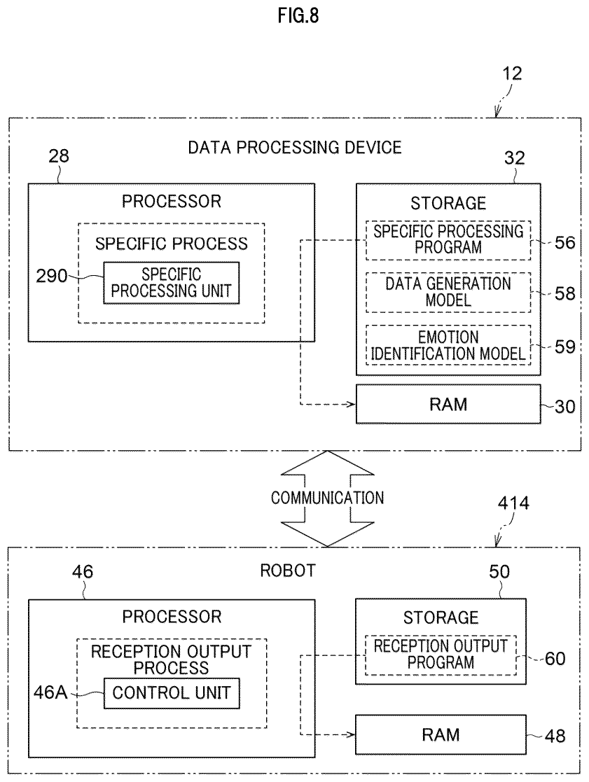

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

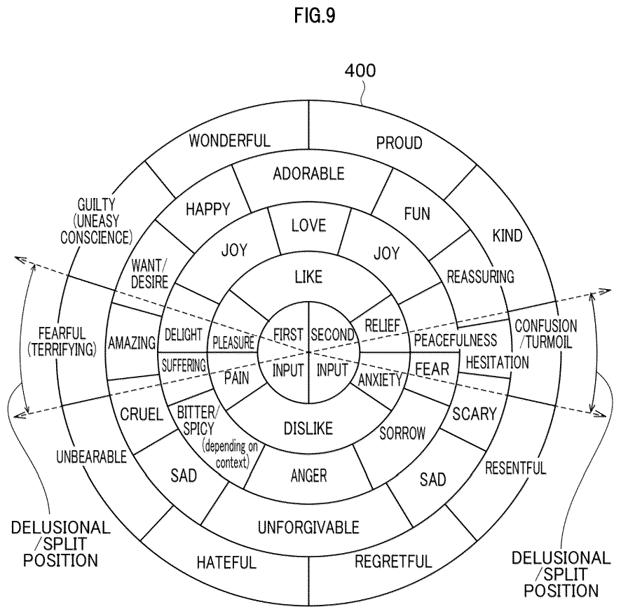

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

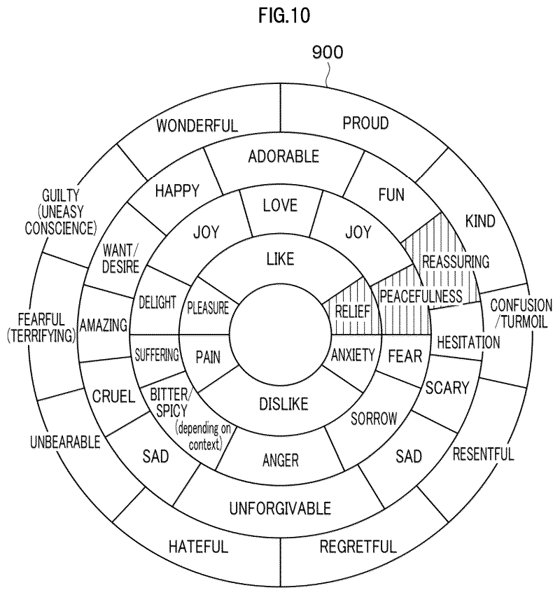

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to acquire audio information received on a user terminal, perform signal processing including noise suppression on the audio information, and convert the audio information into character information by executing a speech recognition process,
wherein the processor is configured to perform, on the character information, language determination processing and character normalization processing, segment the character information into sentences, compare the segmented character information with stored phrase pattern information related to fraudulent activity by rule-based processing, calculate a risk value related to the fraudulent activity by statistical processing using, as input features, contextual information and a machine learning model, and determine a risk evaluation value of the fraudulent activity by integrating a result of the rule-based processing and a result of the statistical processing,
wherein the processor is configured to acquire, as message information received on the user terminal, subject information, body information, sender information, and link information, perform rule-based processing and statistical processing similar to those for the character information so as to determine a risk evaluation value related to fraudulent activity of the message information, and execute link analysis processing that analyzes a character string structure of destination information included in the link information to detect suspicious destination information,
wherein the processor is configured to, when the risk evaluation value determined by at least one of the character information processing and the message information processing exceeds a threshold, generate warning information including specific avoidance actions for a user based on the risk evaluation value and phrase patterns detected by the rule-based processing, present the warning information to the user by at least one of screen display and audio output on the user terminal, present operation means corresponding to the warning information, acquire operation content performed by the user on the operation means, and update at least one of the threshold and weighting information used for calculating the risk evaluation value based on the operation content,
wherein the processor is configured to perform communication management processing with an external server so as to update at least one of the phrase pattern information, destination information pattern information, and the machine learning model used in the character information processing and the message information processing,
wherein the processor is configured to cause the external server to input a prompt sentence to a generative artificial intelligence model, acquire, from the generative artificial intelligence model, candidate information including new sentence examples, phrase patterns, and
detection rules related to fraudulent activity, generate learning data for the machine learning model based on the candidate information, cause the machine learning model to be trained or updated using the generated learning data, and receive, from the external server, update information of the trained or updated machine learning model, the phrase pattern information, and the destination information pattern information, and apply the update information to the user terminal through the communication management processing,
and wherein the processor is configured to execute the character information processing, the message information processing, and the warning information presentation processing by using only information stored in a storage device of the user terminal, without transmitting individual contents of the audio information, character information, or message information to the external server, thereby protecting privacy of the user.

### (Supplementary 2)

The system according to supplementary 1,
wherein the processor is configured to statistically calculate, based on past communication history information stored in the storage device of the user terminal, a normal communication pattern, calculate an abnormality degree based on a difference between a feature amount of current audio information or message information and the normal communication pattern, and correct the risk evaluation value according to the abnormality degree.

### (Supplementary 3)

The system according to supplementary 1,
wherein the processor is configured to cause the external server to generate, as the prompt sentence to be input to the generative artificial intelligence model, a prompt sentence including instructions for a process that converts audio information into character information in real time and analyzes a possibility of fraudulent activity, a process that analyzes message information and extracts features related to fraudulent activity, and a process that generates, for improvement of accuracy of the phrase pattern information, the destination information pattern information, and the machine learning model, at least one of rule proposals and learning data, and to automatically update configuration information of at least one of the phrase pattern information, the destination information pattern information, and the machine learning model based on response information acquired from the generative artificial intelligence model.

### Application Example 1

### (Supplementary 1)

A system comprising a processor,
wherein the processor is configured to acquire acoustic information from an acoustic acquisition apparatus, perform pre-processing on the acoustic information to generate acoustic features, and perform speech recognition processing on the acoustic information to generate character information,
analyze the generated character information by executing language information analysis processing including extraction of expressions, analysis of context, estimation of emotion, and calculation of abnormality, and calculate a threat risk index based on a result of the language information analysis processing,
generate warning information based on the threat risk index, transmit the warning information to a display apparatus or a portable information terminal, receive response information from the portable information terminal, and update and record an event state according to the response information,
generate a learning information set based on past event records and the response information, and update processing conditions or decision thresholds used for classification processing or anomaly detection processing in the language information analysis processing,
generate a prompt sentence for a generative information processing model based on performance information including detection results of the system, false detection cases, and missed detection cases, transmit the prompt sentence to the generative information processing model, obtain proposal information from the generative information processing model, and change at least one of the processing conditions, the decision thresholds, and a warning information generation rule according to the proposal information, and
transmit and receive, between a plurality of the acoustic acquisition apparatuses disposed in a monitoring target area and the portable information terminal, at least one of the acoustic information, the warning information, and information relating to the event state, and perform management processing to distribute the changed processing conditions or the decision thresholds to each apparatus.

### (Supplementary 2)

The system according to supplementary 1,
wherein the processor is configured to generate a feature amount based on time-series character information, position information, and an emotion estimation result, calculate the abnormality by anomaly detection processing on the feature amount, and calculate the threat risk index by weighted synthesis of a score based on keyword detection, an urgency degree based on the emotion estimation result, and the abnormality.

### (Supplementary 3)

The system according to supplementary 1,
wherein the processor is configured to include, in the prompt sentence transmitted to the generative information processing model, case information extracted from the learning information set, statistical information relating to the false detection cases or the missed detection cases, and information relating to a current detection processing configuration, store the proposal information obtained from the generative information processing model as setting information, and update, in stages, at least one of the processing conditions and the decision thresholds according to an approval operation by an administrator.

### Example 2

### (Supplementary 1)

A system comprising a processor,
wherein the processor is configured to acquire communication voice data relating to a voice communication performed by a user by using an information processing apparatus, perform at least noise reduction processing and sampling-rate conversion processing on the communication voice data as preprocessing, and convert the preprocessed communication voice data into text information by executing a speech recognition process, as a voice data processing function,
analyze the text information by using a natural language processing model and a classification model, determine presence or absence of an expression related to fraudulent communication in the text information, and calculate score information indicating a fraud risk associated with the text information, as a text data processing function,
extract at least one of acoustic feature information and textual feature information from at least one of the communication voice data and the text information, and estimate an emotional state of the user and an intensity of the emotional state by using an emotion estimation model, as an emotion analysis function,
determine, on the basis of the score information and the emotional state, a risk level of the voice communication from among a plurality of stages, and output risk level information, as an integrated determination function,
select, on the basis of the risk level information and the emotional state, a warning message template from among a plurality of warning message templates, control at least one of a display device and an audio output device of the information processing apparatus so as to present at least one of warning information and caution information to the user, and, in response to an operation input by the user to an operation interface, execute control of the voice communication including at least termination of the voice communication, as a warning notification function,
store pattern information relating to fraudulent communication, keyword information, scenario information, and parameter information of the natural language processing model in a storage device, and provide the pattern information, the keyword information, the scenario information, and the parameter information so as to be referable by the voice data processing function and the text data processing function, as a pattern storage function,
accumulate anonymized metadata including at least the text information, the emotional state, the risk level information, and behavioral information indicating whether the user has terminated the voice communication, and generate summary information on the basis of the anonymized metadata, as an analysis data management function,
generate a prompt sentence including at least the summary information and description of output conditions to be generated, input the prompt sentence and at least part of the summary information into a generative AI model, and acquire an improvement proposal relating to at least one of a fraud detection logic and a warning message content from an output of the generative AI model, as an analysis enhancement function,
update at least one of the pattern information and the parameter information stored in the storage device on the basis of the improvement proposal, as an update processing function, and distribute, through a communication network, at least one of the updated pattern information and the updated parameter information to at least one terminal device so that at least one of the voice data processing function, the text data processing function, and the integrated determination function executed in the at least one terminal device is updated, as an update distribution function.

### (Supplementary 2)

The system according to supplementary 1,
wherein the processor is configured to execute the voice data processing function, the text data processing function, the emotion analysis function, and the integrated determination function as an application program on the information processing apparatus used by the user, and perform at least part of monitoring of the voice communication, conversion of the communication voice data into the text information, estimation of the emotional state, evaluation of the fraud risk, and presentation of the warning information locally on the information processing apparatus.

### (Supplementary 3)

The system according to supplementary 1,
wherein the processor is configured to analyze electronic message data including at least subject information, body information, and sender information, detect feature information related to fraudulent communication by using at least the pattern information and the parameter information stored in the storage device, evaluate a fraud risk for the electronic message data on the basis of a result of the detection and the emotional state of the user, and cause the warning notification function to present warning information in accordance with an evaluation result of the fraud risk.

### Application Example 2

### (Supplementary 1)

A system comprising a processor,
wherein the processor is configured to
acquire an acoustic signal from a monitored area and generate acoustic feature data based on the acoustic signal, and perform speech recognition processing on the acoustic signal or the acoustic feature data to generate character string data,
and perform natural language processing on the character string data to detect threat-related expressions or illicit-activity-related expressions and compute a content-based threat degree, and estimate an emotional state of a speaker based on the acoustic feature data and the character string data and compute an emotion-based indicator including at least one of panic degree and stress degree,
and integrate the content-based threat degree and the emotion-based indicator to compute an integrated threat degree and determine a threat level or an illicit-activity level according to the integrated threat degree,
and, when the threat level or the illicit-activity level equal to or higher than a predetermined level is determined, generate warning information and transmit the warning information to a user information processing apparatus,
and store, as history data, the acoustic signal, the character string data, the content-based threat degree, the emotion-based indicator, the integrated threat degree, the warning information, and an evaluation result related to at least one of these, and generate learning data based on the history data,
and generate a prompt sentence including statistical information based on the learning data and contents of at least one of a false detection case and a missed detection case, input the prompt sentence to a generative AI model as a generative information processing model, and obtain an algorithm improvement proposal related to a threat detection algorithm from the generative AI model,
and update at least one of a processing procedure and a parameter of at least one of a text data processing function, an emotion estimation function, and a threat determination function based on the algorithm improvement proposal,
and cause a distributed information processing apparatus and a terminal apparatus to cooperatively execute these processes.

### (Supplementary 2)

The system according to supplementary 1,
wherein the processor is configured to execute at least part of an audio data processing function, a text data processing function, an emotion estimation function, a threat determination function, and a warning notification function locally on a user information processing apparatus, detect a keyword or a phrase related to a fraudulent request based on the character string data and the emotion-based indicator, output a warning to a user when a possibility of phishing fraud is detected, and perform the processing without transmitting personal information used in the processing to an external information processing apparatus so as to protect privacy.

### (Supplementary 3)

The system according to supplementary 1,
wherein the processor is configured to analyze, on a user information processing apparatus, a subject, a body, and sender information included in electronic communication data received by the user information processing apparatus, detect a feature related to illicit activity, determine a possibility of at least one of sender address spoofing, invalidity of a reference resource, and maliciousness of attached data, correct the integrated threat degree based on the content-based threat degree and the emotion-based indicator obtained by the text data processing function and the emotion estimation function, and output, by a warning notification function, a warning to the user according to a possibility of phishing fraud.

What is claimed is:

1. A system comprising:
circuitry configured to:
construct a prompt data structure instructing a generative neural network model to generate at least one of phrase pattern data, destination pattern data, and classification training data for detecting fraudulent communications, transmit the prompt data structure to the generative neural network model, and receive candidate pattern data from the generative neural network model;
filter, normalize, and label the candidate pattern data to produce validated pattern data;
generate updated training data based on the validated pattern data and train a machine learning classification model using the updated training data;
package the trained machine learning classification model, updated phrase pattern data, and updated destination pattern data into versioned update data; and
transmit the versioned update data to one or more terminal devices via a communication interface coupled to a packet-switched network.

2. The system according to claim 1, wherein the prompt data structure includes a structured text sequence specifying at least one of a target language, a category of fraudulent communication technique, and example phrase patterns, and wherein the generative neural network model comprises a transformer-based architecture with a plurality of self-attention layers.

3. The system according to claim 2, wherein the candidate pattern data received from the generative neural network model includes at least one of sentence examples representing fraudulent communication patterns, phrase patterns indicative of urgency or impersonation, candidate detection rules, and synthetic training samples for the machine learning classification model.

4. The system according to claim 3, wherein the circuitry filters the candidate pattern data by removing duplicates and entries below a confidence threshold, normalizes character encoding and formatting, and assigns classification labels to the filtered candidate pattern data to produce the validated pattern data.

5. The system according to claim 1, wherein the machine learning classification model comprises a neural network trained to output a risk evaluation value for input text data, and wherein the circuitry retrains the machine learning classification model by combining the updated training data with previously accumulated training data stored in a storage device coupled to the packet-switched network.

6. The system according to claim 5, wherein the circuitry evaluates the retrained machine learning classification model against a validation data set to compute accuracy and false positive rate metrics, and promotes the retrained model to the versioned update data only when the accuracy exceeds a first threshold and the false positive rate is below a second threshold.

7. The system according to claim 6, wherein the versioned update data includes a version identifier, compatibility information corresponding to different terminal device capabilities, and differential update information representing only parameters that changed from a previous version to reduce transmission size.

8. The system according to claim 1, wherein the destination pattern data includes uniform resource locator patterns associated with known fraudulent destinations and domain similarity scoring parameters for detecting impersonated domains, and wherein the circuitry updates the destination pattern data based on destination information included in the candidate pattern data received from the generative neural network model.

9. The system according to claim 8, wherein the circuitry further generates attachment risk pattern data identifying file type signatures and behavioral indicators associated with malicious programs, and includes the attachment risk pattern data in the versioned update data.

10. The system according to claim 1, wherein the versioned update data includes configuration data instructing each terminal device to perform on-device processing including acquiring audio data from a voice communication session, converting the audio data into text data using a speech recognition model executing locally on the terminal device, and analyzing the text data using the trained machine learning classification model executing locally on the terminal device.

11. The system according to claim 10, wherein the configuration data further instructs each terminal device to perform rule-based pattern matching using the updated phrase pattern data on the text data and to perform link analysis using the updated destination pattern data on message data received on the terminal device, and to compute the risk evaluation value based on a combination of the machine learning classification output, the pattern matching output, and the link analysis output.

12. The system according to claim 11, wherein the configuration data further instructs each terminal device to generate a warning notification when the risk evaluation value exceeds a threshold, and to perform all of the speech recognition, pattern matching, link analysis, and classification locally on the terminal device without transmitting the audio data, the text data, or the message data to the circuitry.

13. The system according to claim 1, wherein the versioned update data further includes behavioral baseline parameters, and wherein the configuration data instructs each terminal device to compute an abnormality degree based on a difference between current communication characteristics and the behavioral baseline parameters.

14. The system according to claim 13, wherein the current communication characteristics include at least one of call frequency, call duration distribution, and message volume patterns, and wherein the terminal device incorporates the abnormality degree into the risk evaluation value as a weighted factor.

15. The system according to claim 1, wherein the circuitry is further configured to:
receive, via the communication interface, anonymized feedback data from the one or more terminal devices indicating at least one of false positive reports and missed detection reports; and
incorporate the anonymized feedback data into the updated training data for retraining the machine learning classification model.

16. The system according to claim 15, wherein the circuitry adjusts the prompt data structure based on the anonymized feedback data to instruct the generative neural network model to generate additional candidate pattern data targeting categories of fraudulent communications associated with the missed detection reports.

17. The system according to claim 16, wherein the circuitry estimates a user anxiety level based on interaction frequency patterns included in the anonymized feedback data, and adjusts a sensitivity parameter in the versioned update data to lower the risk evaluation threshold for terminal devices associated with higher estimated anxiety levels.

18. A system comprising:
a communication interface including a network interface controller coupled to a packet-switched network and configured to transmit and receive data packets;
a memory storing instructions, a generative neural network model comprising a transformer architecture with a plurality of self-attention layers, a machine learning classification model, phrase pattern data, and destination pattern data; and
circuitry comprising one or more processors coupled to the memory and configured to execute the instructions to:
construct a prompt data structure instructing the generative neural network model to generate candidate pattern data for detecting fraudulent communications, transmit the prompt data structure to the generative neural network model, and receive the candidate pattern data;
filter, normalize, and label the candidate pattern data to produce validated pattern data;
retrain the machine learning classification model using training data derived from the validated pattern data, and evaluate the retrained model against a validation data set;
package the retrained machine learning classification model, updated phrase pattern data, and updated destination pattern data into versioned update data including version identifiers and compatibility information; and
transmit the versioned update data to one or more terminal devices via the communication interface, the versioned update data including configuration data instructing each terminal device to perform on-device speech recognition, pattern matching, and classification without transmitting communication content to the circuitry.

19. The system according to claim 18, wherein the circuitry is further configured to receive anonymized feedback data from the one or more terminal devices, adjust the prompt data structure based on the feedback data to target missed detection categories, and retrain the machine learning classification model incorporating the feedback data.

20. A method performed by circuitry of a server coupled to a packet-switched network via a communication interface, the method comprising:
constructing a prompt data structure instructing a generative neural network model to generate at least one of phrase pattern data, destination pattern data, and classification training data for detecting fraudulent communications, transmitting the prompt data structure to the generative neural network model, and receiving candidate pattern data from the generative neural network model;
filtering, normalizing, and labeling the candidate pattern data to produce validated pattern data;
generating updated training data based on the validated pattern data and training a machine learning classification model using the updated training data;
packaging the trained machine learning classification model, updated phrase pattern data, and updated destination pattern data into versioned update data; and
transmitting the versioned update data to one or more terminal devices via the communication interface.
